(19) United States
(12) Patent Application Publication
(10) Pub. No.: US 2026/0211607 A1
(43) Pub. Date: Jul. 23, 2026

(54) ELECTRONIC APPARATUS AND CONTROL METHOD THEREOF

(71) Applicant: SAMSUNG ELECTRONICS CO., LTD., Suwon-si (KR)

(72) Inventors: Yunsung Jung, Suwon-si (KR); Jinoh KIM, Suwon-si (KR)

(73) Assignee: SAMSUNG ELECTRONICS CO., LTD., Suwon-si (KR)

(21) Appl. No.: 19/572,198

(22) Filed: Mar. 19, 2026

Related U.S. Application Data
(63) Continuation of application No. PCT/KR2025/022197, filed on Dec. 18, 2025.

(30) Foreign Application Priority Data
Jan. 2, 2025 (KR) 10-2025-0000343

(51) Int. Cl. G06F 3/14; G06F 3/04845; G06F 3/0488

(52) U.S. Cl. CPC G06F 3/1454; G06F 3/04845; G06F 3/0488; G06F 3/1423

(57) ABSTRACT

An electronic apparatus may include: a communication interface; a driving part configured to move the electronic apparatus; a projection part configured to project a moving image; a memory configured to store instructions; and at least one processor configured to, collectively or individually, execute the stored instructions to: based on a user input to edit a user interface (UI) element corresponding to a projection area received through a terminal device, receive, through the communication interface, information about an edited projection area that corresponds to the edited UI element, and control the driving part, the projection part, or a combination thereof, such that the moving image is projected based on a projection angle and/or a projection position obtained through the received information.

### CROSS-REFERENCE TO RELATED APPLICATION

This application is a continuation application of International Patent Application No. PCT/KR2025/022197, filed on December 18, 2025, which claims priority from Korean Patent Application No. 10-2025-0000343, filed on January 02, 2025, in the Korean Intellectual Property Office, the disclosures of which are incorporated herein by reference in their entireties.

### BACKGROUND

### 1. Field

The disclosure relates to an electronic apparatus and a control method thereof.

### 2. Description of Related Art

Due to developments in electronic technology, electronic apparatuses of various types are being developed and distributed. As one from among the above, recently, home robots that assist in the lives of users while moving in an indoor space, and perform appropriate activities are being used. Through the home robots described, a convenient and efficient lifestyle may be supported for users.

In an example, a home robot may project a moving image on a wall surface. The home robot may project, at the request of a user, a moving image content or a screen of a terminal device used by the user at a wall surface designated by the user.

At this time, in order for the user to change a size or a position of the screen, a position of the home robot or an angle of a projector has to be adjusted. At this time, there is growing need for technology for users to more effectively adjust the screen to be projected.

### Disclosure

### SUMMARY

In accordance with the present disclosure, an electronic apparatus may include: a communication interface; a driving part configured to move the electronic apparatus; a projection part configured to project a moving image; a memory configured to store instructions; and at least one processor configured to, collectively or individually, execute the stored instructions to: based on a user input to edit a user interface (UI) element corresponding to a projection area received through a terminal device, receive, through the communication interface, information about an edited projection area that corresponds to the edited UI element, and control the driving part, the projection part, or a combination thereof, such that the moving image is projected based on a projection angle and/or a projection position obtained through received information.

The stored instructions, executed collectively or individually by the at least one processor, may be further configured to: receive, through the communication interface, an image of an area from the terminal device, and transmit, through the communication interface, information about a projection candidate area in a background area of the received image to the terminal device, the background area may include a space between objects included in the received image.

The terminal device may output the edited projection area that corresponds to the edited UI element in the projection candidate area, and the received information about the edited projection area that corresponds to the edited UI element may include a size of the edited UI element, a form of the edited UI element, a position of the edited UI element, or a combination thereof.

The stored instructions, executed collectively or individually by the at least one processor, may be further configured to: based on an obstacle being present in a surrounding of the projection position obtained through the received information, transmit, through the communication interface, data corresponding to a substitute position for the projection position to the terminal device, and based on a user input corresponding to the transmitted data received through the terminal device, control the driving part, the projection part, or a combination thereof, to project the moving image from the substitute position.

The stored instructions, executed collectively or individually by the at least one processor, may be further configured to: identify an area of a minimum size or more to which the moving image may be projectable as the projection candidate area.

The memory may be further configured to store three-dimensional (3D) map data, and the stored instructions, executed collectively or individually by the at least one processor, may be further configured to: control the driving part to move the electronic apparatus to a position corresponding to an area based on the received image and the stored 3D map data.

The stored instructions, executed collectively or individually by the at least one processor, may be further configured to: based on the projected moving image, transmit, through the communication interface, information about a projection area to which the moving image may be projected to the terminal device.

The terminal device may output the projection area to which the moving image may be projected in an image that captured the projection area, and the received information about the edited projection area that corresponds to the edited UI element may include a size of the edited UI element, a form of the edited UI element, and a position of the edited UI element, or a combination thereof.

The stored instructions, executed collectively or individually by the at least one processor, may be further configured to: based on an obstacle being present in a surrounding of the projection position obtained through the received information, transmit, through the communication interface, data corresponding to a substitute position for the projection position to the terminal device, and based on a user input corresponding to the transmitted data received through the terminal device, control the driving part, the projection part, or a combination thereof, to project the moving image from the substitute position.

The user input may be a first user input, and the stored instructions, executed collectively or individually by the at least one processor, may be further configured to: with the UI element edited through the terminal device, based on a second user input to edit the UI element corresponding to the projection area not being received for a threshold time or more through the terminal device, the second user input subsequent to the first user input, control the driving part, the projection part, or a combination thereof to project the moving image based on the projection angle and/or the projection position obtained through the received information corresponding to the first user input.

In accordance with the present disclosure, a control method of an electronic apparatus including a communication interface, a driving part configured to move the electronic apparatus, a projection part configured to project a moving image, and at least one processor, may include: based on receiving a user input for editing a user interface (UI) element corresponding to a projection area through a terminal device, receiving, through the communication interface, information about an edited projection area that corresponds to the edited UI element, and projecting the moving image based on a projection angle and/or a projection position obtained through the received information.

The method may further include: by the at least one processor, collectively or individually, receiving, through the communication interface, an image of an area from the terminal device, and transmitting, through the communication interface, information about a projection candidate area in a background area of the received image to the terminal device, the background area including a space between objects included in the received image.

The terminal device may output the edited projection area that corresponds to the edited UI element in the projection candidate area, and the received information about an edited projection area may include a size of the edited UI element, a form of the edited UI element, a position of the UI element, or a combination.

The method may further include: based on an obstacle being present in a surrounding of the projection position obtained through the received information, transmitting, through the communication interface, data corresponding to a substitute position for the projection position to the terminal device, and based on receiving a user input corresponding to the transmitted data through the terminal device, projecting the moving image from the substitute position.

The transmitting information about the projection candidate area to the terminal device may include: identifying an area of a minimum size or more to which the moving image may be projectable as the projection candidate area.

In accordance with the present disclosure, a non-transitory computer-readable recording medium including a program for executing a control method for an electronic method including a communication interface, a driving part configured to move the electronic apparatus, a projection part configured to project a moving image, and at least one processor, may include: based on receiving a user input for editing a user interface (UI) element corresponding to a projection area through a terminal device, receiving, through the communication interface, information about an edited projection area that corresponds to the edited UI element, and projecting the moving image based on a projection angle and/or a projection position obtained through the received information.

The non-transitory computer-readable recording medium may further include: by the at least one processor, collectively or individually, receiving, through the communication interface, an image of an area from the terminal device, and transmitting, through the communication interface, information about a projection candidate area in a background area of the received image to the terminal device, the background area including a space between objects included in the received image.

The terminal device may output the edited projection area that corresponds to the edited UI element in the projection candidate area, and the received information about an edited projection area may include a size of the edited UI element, a form of the edited UI element, a position of the UI element, or a combination.

The non-transitory computer-readable recording medium may further include: based on an obstacle being present in a surrounding of the projection position obtained through the received information, transmitting, through the communication interface, data corresponding to a substitute position for the projection position to the terminal device, and based on receiving a user input corresponding to the transmitted data through the terminal device, projecting the moving image from the substitute position.

The transmitting information about the projection candidate area to the terminal device may include: identifying an area of a minimum size or more to which the moving image may be projectable as the projection candidate area.

### BRIEF DESCRIPTION OF THE DRAWINGS

FIG. 1 is a diagram schematically illustrating an operation of an electronic apparatus according to an embodiment of the disclosure;

FIG. 2 is a block diagram illustrating a configuration of an electronic apparatus according to an embodiment of the disclosure;

FIG. 3A and FIG. 3B are diagrams illustrating an exterior of an electronic apparatus according to various embodiments of the disclosure;

FIG. 4 is a block diagram illustrating a configuration of a terminal device according to an embodiment of the disclosure;

FIG. 5 is a flowchart illustrating a method for editing a projection area while an electronic apparatus is projecting a moving image according to an embodiment of the disclosure;

FIG. 6A to FIG. 6C are diagrams illustrating an operation of an electronic apparatus according to a user input in a terminal device according to an embodiment of the disclosure;

FIG. 7 is a flowchart illustrating an operation of an electronic apparatus and a terminal device if there is 3D map data according to an embodiment of the disclosure;

FIG. 8 is a diagram illustrating an electronic apparatus moving based on 3D map data and an image according to an embodiment of the disclosure;

FIG. 9 is a diagram illustrating a projection candidate area included in a captured image and a UI element according to an embodiment of the disclosure;

FIG. 10 is a diagram illustrating an example of an obstacle being present in a surrounding of a projection position according to an embodiment of the disclosure;

FIG. 11 is a diagram illustrating an option for being displayed in a terminal device according to an embodiment of the disclosure; and

FIG. 12 is a flowchart illustrating a control method of an electronic apparatus according to an embodiment of the disclosure.

### DETAILED DESCRIPTION

Various modifications may be made to the embodiments of the disclosure, and there may be various types of embodiments. Accordingly, specific embodiments will be illustrated in drawings, and the embodiments will be described in detail in the detailed description. However, it should be noted that the various embodiments are not for limiting the scope of the disclosure to a specific embodiment, but they should be interpreted to include all modifications, equivalents or alternatives of the embodiments included in the ideas and the technical scopes disclosed herein. With respect to the description of the drawings, like reference numerals may be used to indicate like elements.

In describing the disclosure, in case it is determined that the detailed description of related known technologies or configurations may unnecessarily confuse the gist of the disclosure, the detailed description thereof will be omitted.

Further, the embodiments below may be modified to various different forms, and it is to be understood that the scope of the technical spirit of the disclosure is not limited to the embodiments below. Rather, the embodiments are provided so that the disclosure will be thorough and complete, and to fully convey the technical spirit of the disclosure to those skilled in the art.

Terms used in the disclosure have been merely used to describe a specific embodiment, and is not intended to limit the scope of protection. A singular expression includes a plural expression, unless otherwise specified.

In the disclosure, expressions such as “have”, “may have”, “include”, and “may include” are used to designate a presence of a corresponding characteristic (e.g., elements such as numerical value, function, operation, or component), and not to preclude a presence or a possibility of additional characteristics.

In the disclosure, expressions such as “A or B”, “at least one of A and/or B”, or “one or more of A and/or B” may include all possible combinations of the items listed together. For example, “A or B”, “at least one of A and B”, or “at least one of A or B” may refer to all cases including (1) at least one A, (2) at least one B, or (3) both of at least one A and at least one B.

Expressions such as “1st”, “2nd”, “first”, or “second” used in the disclosure may limit various elements regardless of order and/or importance, and may be used merely to distinguish one element from another element and not limit the relevant element.

When a certain element (e.g., a first element) is indicated as being “(operatively or communicatively) coupled with/to” or “connected to” another element (e.g., a second element), it may be understood as the certain element being directly coupled with/to the another element or as being coupled through other element (e.g., a third element).

Conversely, when the certain element (e.g., first element) is indicated as “directly coupled with/to” or “directly connected to” another element (e.g., second element), it may be understood as the other element (e.g., third element) not being present between the certain element and the another element.

The expression “configured to… (or set up to)” used in the disclosure may be used interchangeably with, for example, “suitable for…”, “having the capacity to…”, “designed to…”, “adapted to…”, “made to…”, or “capable of…” based on circumstance. The term “configured to… (or set up to)” may not necessarily mean “specifically designed to” in terms of hardware.

Rather, in a certain circumstance, the expression “a device configured to…” may mean something that the device “may perform…” together with another device or components. For example, a phrase “a processor configured to (or set up to) perform A, B, or C” may mean a dedicated processor for performing a relevant operation (e.g., an embedded processor), or a generic-purpose processor (e.g., a central processing unit (CPU) or an application processor) capable of performing the relevant operations by executing one or more software programs stored in a memory device.

The term ‘module’ or ‘part’ used in embodiments herein perform at least one function or operation, and may be implemented with hardware or software, or implemented with a combination of hardware and software. In addition, a plurality of ‘modules’ or a plurality of ‘parts’, except for a ‘module’ or a ‘part’ which needs to be implemented with a specific hardware, may be integrated in at least one module and implemented as at least one processor.

An embodiment of the disclosure will be described in greater detail below with reference to the accompanied drawings.

Meanwhile, the various elements and areas of the drawings have been schematically illustrated. Accordingly, the technical spirit of the disclosure is not limited by relative sizes and distances illustrated in the accompanied drawings.

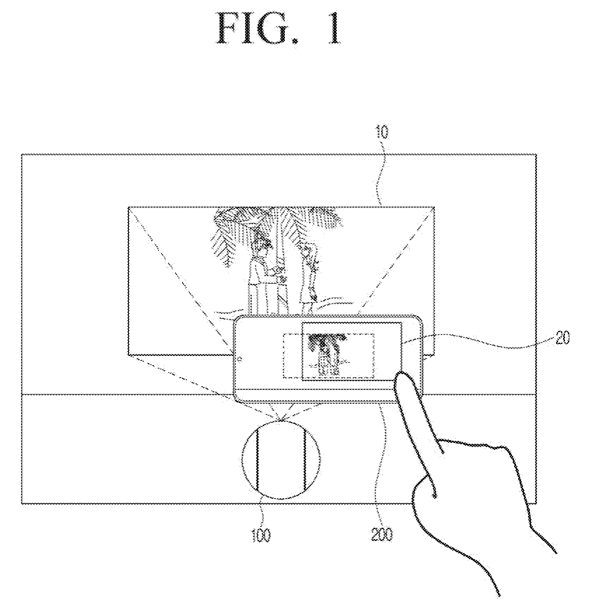

FIG. 1 is a diagram schematically illustrating an operation of an electronic apparatus 100 according to at least one embodiment of the disclosure.

According to an embodiment, the electronic apparatus 100 may project a moving image to a projection area.

According to various embodiments of the disclosure, the electronic apparatus 100 may be apparatuses of various types capable of traveling. In an example, the electronic apparatus 100 may be a moving-type electronic apparatus 100 that includes a projector. In addition thereto, the electronic apparatus 100 may be implemented as a moving-type robot, a robot cleaner, a wireless speaker, an automated guided vehicle (AGV), an autonomous mobile robot (AMR), a social robot, and the like. Although the various embodiments of the disclosure have been shown and described based on being implemented as an apparatus capable of travel, but in some embodiments, the above may be implemented as an electronic apparatus in a form that is not capable of autonomous travel but convenient for position movement.

Among the electronic apparatuses capable of travel, in particular, an example of when implemented as an electronic apparatus 100 that includes a projection part will be described below.

The electronic apparatus 100 described above may travel to a random position within a space (e.g., within a home) in which the apparatus is placed, and project a moving image to various projection surfaces such as, for example, and without limitation, a wall surface or a surface of a furniture, a dedicated screen, a floor surface, a ceiling, and the like.

Referring to FIG. 1, a terminal device 200 may obtain an image that captured a projection area 10 on which the electronic apparatus 100 is projecting a moving image.

The projection area 10 may be an area in which the electronic apparatus 100 is projecting the moving image onto a projection surface.

The terminal device 200 may overlay and display a UI element 20 corresponding to the projection area 10 over an image that captured the projection area 10. The UI element 20 corresponding to the projection area 10 may be a UI element 20 which corresponds in size and position with the projection area 10 included in the image. The UI element 20 may otherwise be referred to as a graphic object, or an editing layer.

The terminal device 200 may display an edited UI element by receiving a user input for editing the UI element 20. The terminal device 200 may display a UI element with at least one from among a size, a form, and a position edited by receiving a user input for editing of at least one from among the size, the form, and the position of the UI element 20.

The electronic apparatus 100 may identify a projection angle and a projection position of the electronic apparatus 100 through information about an edited projection area 10 by receiving information about the edited projection area that corresponds to an edited UI element from the terminal device 200. The edited projection area 10 may be a projection area 10 with at least one from among a size, a form, and a position thereof edited by a user input for editing the UI element. Information about the edited projection area 10 may include information corresponding to a user input for editing the UI element, information about the UI element 20 after editing, and information about a difference in the UI element before and after editing. Information about the UI element 20 may be information about at least one from among a size, a form, and a position of the UI element 20. Alternatively, the information about the UI element 20 may be information about a relative size and position of the UI element on the image.

The electronic apparatus 100 may project a moving image based on the obtained projection angle and projection position. The projection angle may be an angle at which the electronic apparatus 100 projects the moving image onto the projection surface. The projection position may be a position for the electronic apparatus 100 to project the moving image onto the projection surface.

In FIG. 1, although an example of the electronica apparatus 100 operating within a home has been shown, the electronic apparatus 100 may be used in various environments such as, for example, and without limitation, factories, offices or inside a building, public offices, and the like.

Various embodiments of the electronic apparatus 100 performing a function of editing a projection area by a user input through the terminal device 200 will be described below with reference to the drawings.

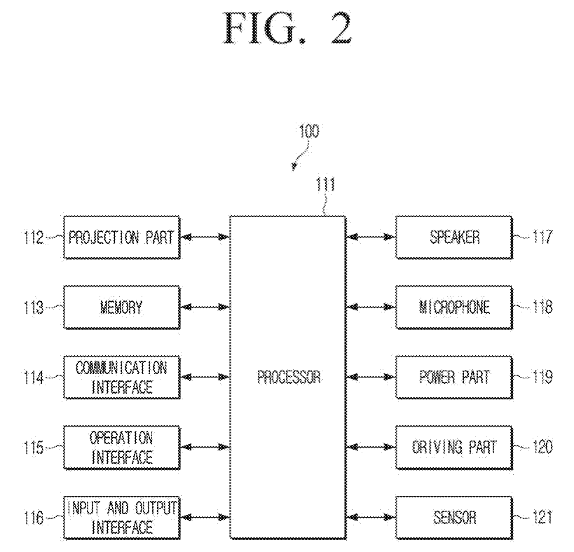

FIG. 2 is a block diagram schematically illustrating a configuration of the electronic apparatus 100 according to at least one embodiment of the disclosure.

Referring to FIG. 2, the electronic apparatus 100 may include at least one from among a processor 111, a projection part 112, memory 113, a communication interface 114, an operation interface 115, an input and output interface 116, a speaker 117, a microphone 118, a power part 119, a driving part 120, or a sensor 121. Meanwhile, configurations shown in FIG. 2 are merely various embodiments, and a portion of the configurations may be omitted, and a new configuration may be added. As described above, the electronic apparatus 100 may not only move using the driving part 120, but also be moved by a user. Although embodiments implemented by the electronic apparatus 100 that includes the driving part 120 will mainly be described below, the embodiments described below may be applied likewise to even when the electronic apparatus 100 does not use the driving part 120 included in the electronic apparatus 100, or when the electronic apparatus 100 does not include the driving part 120.

The projection part 112 may be a configuration for externally projecting an image. According to various embodiments of the disclosure, the projection part 112 may be implemented with various projection methods (e.g., a cathode-ray tube (CRT) method, a liquid crystal display (LCD) method, a digital light processor (DLP) method, a laser method, etc.). In an example, the CRT method may be basically same in principle as a CRT monitor. The CRT method may display an image on a screen by enlarging the image with a lens in front of a cathode-ray tube (CRT). The method may be classifed into a single-tube type and a three-tube type depending on a number of cathode-ray tubes, and in the case of the three-tube type, cathode-ray tubes of red, green, and blue may be separated individually and implemented.

In another example, the LCD method may be a method for displaying an image by transmitting light emitted from a light source to a liquid crystal display. The LCD method may be divided into a single-panel type and a three-panel type, and in the case of the three-panel type, light emitted from a light source may be separated into red, green, and blue in a dichroic mirror (a mirror which reflects only light of a specific color and passes the remaining colors) and then gather back in one place after passing the liquid crystal display.

In still another example, the DLP method may be a method for displaying an image using a digital micromirror device (DMD) chip. A projection part of the DLP method may include a light source, a color wheel, a DMB chip, a projection lens, and the like. Light output from the light source may show a color as it passes a rotating color wheel. The light that passed the color wheel may be input in the DMD chip. The DMD chip may include many micromirrors, and may reflect light input in the DMD chip. The projection lens may perform a role of expanding the light reflected from the DMD chip to a size of an image.

In still another example, the laser method may include a diode pumped solid state (DPSS) laser and a galvanometer. The laser that outputs various colors may use a laser that superimposes optical-axes using a special mirror after installing three DPSS lasers for each RGB color. The galvanometer may include a mirror and a motor with high output, and may move the mirror at a fast speed. For example, the galvanometer may rotate the mirror at a maximum of 40 KHz/sec. The galvanometer may be mounted along a scanning direction, and because the projector typically scans a flat surface, the galvanometer may also be disposed divided along the x and y axes.

Meanwhile, the projection part 112 may include light sources of various types. For example, the projection part 112 may include at least one light source from among a lap, an LED, or a laser.

The projection part 112 may output an image at a 4:3 aspect ratio, a 5:4 aspect ratio, and a 16:9 wide aspect ratio according to use of the electronic apparatus 100 or user setting, and may output images in various resolutions such as, for example, and without limitation, WVGA(854*480), SVGA(800*600), XGA(1024*768), WXGA(1280*720), WXGA(1280*800), SXGA(1280*1024), UXGA(1600*1200), Full HD(1920*1080), and the like according to the aspect ratio.

Meanwhile, the projection part 112 may perform various functions for adjusting an output image by control of the processor 111. For example, the projection part 112 may perform functions such as, for example, and without limitation, zoom, keystone, quick-corner (4-corner) keystone, lens shift, and the like.

Specifically, the projection part 112 may enlarge or reduce an image according to a distance (projection distance) with a screen. In other words, the zoom function may be performed according to the distance with the screen. At this time, the zoom function may include a hardware method of adjusting a size of the screen by moving the lens, and a software method of adjusting a size of the screen with cropping an image, and the like. Meanwhile, when the zoom function is performed, an adjustment of focal point of the image may be necessary. For example, the method of adjusting focal point may include a manual focusing method, a motor-driven method, and the like. The manual focusing method may mean a method of manually adjusting the focal point, and the motor-driven method may mean a method of automatically adjusting the focal point by using a motor embedded with a projector when the zoom function is performed. When the zoom function is performed, the projection part 112 may provide a digital zoom function through software, and provide an optical zoom function that performs the zoom function by moving the lens through a rotation part.

In addition, the projection part 112 may perform a keystone correction function. If a height of front projection is not right, the screen may be distorted at the top or bottom. The keystone correction function may mean a function for correcting a distorted screen. For example, if distortion occurs in the left and right directions of the screen, correction may be made using a horizontal keystone, and if distortion occurs in the top and bottom directions, correction may be made using a vertical keystone. The quick-corner (4-corner) keystone correction function may be a function for correcting the screen in case a center area of the screen is normal but balance at corner areas are not right. The lens shift function may be a function which moves the screen in its entirety if the screen is outside of the screen.

Meanwhile, the projection part 112 may provide the zoom/keystone/focus function by automatically analyzing the surrounding environment and the projection environment without a user input. Specifically, the projection part 112 may automatically provide the zoom/keystone/focus function based on a distance between the electronic apparatus 100 and the screen detected through a senor (depth camera, distance sensor, infrared sensor illuminance sensor, etc.), information about a space in which the electronic apparatus 100 is currently positioned, information about an amount of ambient light, and the like.

In addition, the projection art 112 may provide a lighting function using a light source. Specifically, the projection part 112 may provide the lighting function by outputting the light source using an LED. The projection part 112 according to various embodiments may include one LED, and the electronic apparatus 100 according to another embodiment may include a plurality of LEDs. Meanwhile, the projection part 112 may output the light source using a surface emitting LED according to an embodiment. Here, the surface emitting LED may mean an LED having a structure in which an optical sheet is disposed at an upper side of the LED for the light source to be uniformly distributed and output. Specifically, when the light source is output through the LED, the light source may be uniformly distributed through the optical sheet, and the light source distributed through the optical sheet may be incident to a display panel.

Meanwhile, the projection part 112 may provide the user with a dimming function for adjusting an intensity of the light source. Specifically, when a user input for adjusting the intensity of the light source is received from the user through an operation interface 115 (e.g., a touch display button or a dial), the projection part 112 may control the LED to output the intensity of the light source that corresponds to the received user input.

In addition, the projection part 112 may provide the dimming function based on content analyzed by the processor 111 without user input. Specifically, the projection part 112 may control the LED to output the intensity of the light source based on information about a content (e.g., a type of content, brightness of content, etc.) that is currently being provided.

Meanwhile, the projection part 112 may control a color temperature by control of the processor 111. Here, the processor 111 may control the color temperature based on the content. Specifically, when a content is identified as to be output, the processor 111 may obtain color information by frame of the content that is determined for output. Then, the processor 111 may control the color temperature based on the obtained color information by frame. Here, the processor 111 may obtain at least one or more main colors of a frame based on the color information by frame. Then, the processor 111 may adjust the color temperature based on the obtained at least one or more main colors. For example, the color temperature that can be adjusted by the processor 111 may be divided into a warm type or a cold type. Here, it may be assumed that a frame to be output (hereinafter, referred to as ‘output frame’) includes a scene in which a fire occurred. The processor 111 may identify (or obtain) that the main color is red based on the color information included in the currently output frame. Then, the processor 111 may identify the color temperature corresponding to the identified main color (red). Here, the color temperature corresponding to red may be the warm type. Meanwhile, the processor 111 may use an artificial intelligence model to obtain the color information of a frame or the main color. According to various embodiments, the artificial intelligence model may be stored in the electronic apparatus 100 (e.g., memory 113). According to another embodiment, the artificial intelligence model may be stored in an external server communicable with the electronic apparatus 100.

Meanwhile, the projection part 112 may include a long-focus projection lens and an ultra-short focus projection lens. The long-focus projection lens may be a lens capable of projecting to a large screen from a long distance, and may project a moving image from even positions that are several meters to tens of meters apart. The ultra-short focus projection lens may be a lens capable of projecting to a large screen from a very short distance, and may project a moving image from even positions that are several centimeters apart.

In addition, the projection part 112 may further include a switching part capable of switching (or changing, tilting) the long-focus projection lens and the ultra-short focus projection lens. In other words, the projection part 112 may switch between the long-focus projection lens and the ultra-short focus projection lens using the switching part by control of the processor 111.

The memory 113 may be implemented as an internal memory such as a read only memory (ROM) (e.g., an electrically erasable programmable read-only memory (EEPROM)) or a random access memory (RAM) included in the processor 111, or implemented as a memory separate from the processor 111. In this case, the memory 113 may be implemented in a form of a memory embedded in the electronic apparatus 100 according to data storage use, or implemented in a form of a memory attachable to or detachable from the electronic apparatus 100. For example, data for driving of the electronic apparatus 100 may be stored in the memory embedded in the electronic apparatus 100, and data for an expansion function of the electronic apparatus 100 may be stored in the memory attachable to or detachable from the electronic apparatus 100.

Meanwhile, the memory embedded in the electronic apparatus 100 may be implemented as at least one of a volatile memory (e.g., a dynamic RAM (DRAM), a static RAM (SRAM), or a synchronous dynamic RAM (SDRAM)), or a non-volatile memory (e.g., a one time programmable ROM (OTPROM), a programmable ROM (PROM), an erasable and programmable ROM (EPROM), an electrically erasable and programmable ROM (EEPROM), a mask ROM, a flash ROM, a flash memory (e.g., NAND flash or NOR flash), a hard disk drive (HDD) or a solid state drive (SSD)), and the memory attachable to or detachable from the electronic apparatus 100 may be implemented in a form such as, for example, and without limitation, a memory card (e.g., a compact flash (CF), a secure digital (SD), a micro secure digital (micro-SD), a mini secure digital (mini-SD), an extreme digital (xD), a multi-media card (MMC), etc.), an external memory (e.g., a USB memory) connectable to a USB port, or the like.

The memory 113 may be stored with at least one instruction associated with the electronic apparatus 100. Further, the memory 113 may be stored with an operating system (O/S) for driving the electronic apparatus 100. In addition, the memory 113 may be stored with various software programs or applications for the electronic apparatus 100 to operate according to various embodiments of the disclosure. Further, the memory 113 may include a semiconductor memory such as the flash memory, a magnetic storage medium such as a hard disk, or the like.

Specifically, the memory 113 may be stored with various software modules for the electronic apparatus 100 to operate according to the various embodiments of the disclosure, and the processor 111 may control an operation of the electronic apparatus 100 by executing the various software modules stored in the memory 113. In other words, the memory 113 may be accessed by the processor 111, and reading/writing/modifying/deleting/updating, and the like of data may be performed by the processor 111.

Specifically, the memory 113 may store information about a map within a home in which the electronic apparatus 100 is positioned. At this time, the map may include a drawing in which a floor structure within the home is reduced to a certain ratio, and represented with agreed symbols of the above. For example, the map may include a drawing indicating the floor structure inside the home with lines. However, the embodiment is not limited thereto, and the map may include positions of main objects inside the home.

Meanwhile, the map according to an embodiment of the disclosure may be a 2-dimensional map, but this is merely one embodiment, and may be a 3-dimensional map.

Meanwhile, the term ‘memory 113’ in the disclosure may be used as a meaning that includes a storage, the ROM (not shown) and the RAM (not shown) in the processor 111, or the memory card (not shown) mounted to the electronic apparatus 100 9e.g., a micro SD card, a memory stick).

The communication interface 114 may be a configuration for performing communication with external devices of various types according to communication methods of various types. The communication interface 114 may include a wireless communication module or a wired communication module. Here, each communication module may be implemented in at least one hardware chip form.

The wireless communication module may be a module for communicating with the external devices via wireless communication. For example, the wireless communication module may include at least one module from among a Wi-Fi module, a Bluetooth module, an infrared communication module, or other communication modules.

The Wi-Fi module and the Bluetooth module may perform communication in the Wi-Fi method and the Bluetooth method, respectively. When using the Wi-Fi module or the Bluetooth module, various connection information such as a service set identifier (SSID) and a session key may first be transmitted and received, and various information may be may transmitted and received after communicatively connecting using the same.

The infrared communication module may perform communication according to an infrared communication (Infrared Data Association (IrDA)) technology of transmitting data wirelessly in short range by using infrared rays present between visible rays and millimeter waves.

The wireless communication module may include at least one communication chip that performs communication according to various wireless communication standards such as, for example, and without limitation, ZigBee, 3rd Generation (3G), 3rd Generation Partnership Project (3GPP), Long Term Evolution (LTE), LTE Advanced (LTE-A), 4th Generation (4G), 5th Generation (5G), and the like, in addition to the above-described communication methods.

The wired communication module may be a module for communicating with the external devices via wired communication. For example, the wired communication module may include at least one from among a local area network (LAN) module, an Ethernet module, a pair cable, a coaxial cable, an optical fiber cable, or an ultra wide-band (UWB) module.

Specifically, the communication interface 114 may perform communication with the terminal device 200. The communication interface 114 may receive information about the terminal device 200 from the terminal device 200 (e.g., information about a current position of the terminal device 200, information about a device included in the terminal device 200, etc.). The communication interface 114 may transmit path information to the terminal device 200, and transmit information about a multi-projector system.

The operation interface 115 may include input devices of various types. For example, the operation interface 115 may include a physical button. At this time, the physical button may include a function key, a direction key (e.g., a 4-direction key), or a dial button. According to various embodiments, the physical button may be implemented as a plurality of keys. According to another embodiment, the physical button may be implemented as one key. Here, if the physical button is implemented as one key, the electronic apparatus 100 may receive a user input of the one key being pressed for a threshold time or more. If the user input of the one key being pressed for a threshold time or more is received, the processor 111 may perform a function corresponding to the user input. For example, the processor 111 may provide the lighting function based on the user input.

In addition, the operation interface 115 may receive a user input using a non-contact method. If a user input is received through a contact method, physical force has to be transferred to the electronic apparatus 100. Accordingly, a method for controlling the electronic apparatus 100 regardless of physical force may be required. Specifically, the operation interface 115 may receive a user gesture, and perform an operation corresponding to the received user gesture. Here, the operation interface 115 may receive the user gesture through a sensor (e.g., an image sensor or an infrared sensor).

In addition, the operation sensor 115 may receive a user input using a touch method. For example, the operation interface 115 may receive a user input through a touch sensor. According to various embodiments, the touch method may be implemented with the non-contact method. For example, the touch sensor may determine whether a body of the user approached within a threshold distance. Here, the touch sensor may identify a user input even when the user has not made contact with the touch sensor. Meanwhile, according to another implementation, the touch sensor may identify a user input of the user contacting the touch sensor.

Meanwhile, the electronic apparatus 100 may receive a user input through various methods in addition to the operation interface 115 described above. In various embodiments, the electronic apparatus 100 may receive a user input through an external remote control device. Here, the external remote control device may be a remote control device corresponding to the electronic apparatus 100 (e.g., a dedicated control device of the electronic apparatus 100) or a mobile communication device of the user (e.g., a smartphone or a wearable device). Here, the mobile communication device of the user may be stored with an application for controlling the electronic apparatus 100. The mobile communication device may obtain a user input through the stored application, and transmit the obtained user input to the electronic apparatus 100. The electronic apparatus 100 may perform an operation corresponding to a control command of the user by receiving a user input from the mobile communication device.

Meanwhile, the electronic apparatus 100 may receive a user input using voice recognition. According to various embodiments, the electronic apparatus 100 may receive a user voice through a microphone included in the electronic apparatus 100. According to another embodiment, the electronic apparatus 100 may receive the user voice from the microphone or an external device. Specifically, the external device may obtain the user voice through a microphone of the external device, and transmit the obtained user voice to the electronic apparatus 100. The user voice transmitted from the external device may be audio data or digital data of the converted audio data (e.g., audio data converted to frequency domain, etc.). Here, the electronic apparatus 100 may perform an operation corresponding to the received user voice. Specifically, the electronic apparatus 100 may receive audio data corresponding to the user voice through the microphone. Then, the electronic apparatus 100 may convert the received audio data to digital data. Then, the electronic apparatus 100 may convert digital data converted using a speech to text (STT) function to text data. According to various embodiments, the speech to text (STT) function may be directly performed in the electronic apparatus 100, and according to another embodiment, the speech to text (STT) function may be performed in an external server. The electronic apparatus 100 may transmit digital data to the external server. The external server may convert digital data to text data, and obtain control command data based on the converted text data. The external server may transmit the control command data (at this time, text data may also be included) to the electronic apparatus 100. The electronic apparatus 100 may perform an operation that corresponds to the user voice based on the obtained control command data.

Meanwhile, the electronic apparatus 100 may provide a voice recognition function using one assistance (or artificial intelligence assistant, e.g., Bixby^{TM}, etc.), but this is merely according to various embodiments, and may provide the voice recognition function through a plurality of assistances. At this time, the electronic apparatus 100 may provide the voice recognition function by selecting one from among the plurality of assistances based on a trigger word that corresponds to assistance or a specific key present on a remote controller.

Meanwhile, the electronic apparatus 100 may receive a user input using a screen interaction. The screen interaction may mean a function for identifying whether a predetermined event occurs through an image projected on the screen (or projection surface) by the electronic apparatus 100, and obtaining a user input based on the predetermined event. Here, the predetermined event may mean an event in which a predetermined object is identified at a specific position (e.g., a position at which a UI for receiving user input is projected). Here, the predetermined object may include at least one from among a portion of the body of the user (e.g., finger), a pointer, or a laser point. The electronic apparatus 100 may identify, based on a predetermined object being identified at a position corresponding to the projected UI, that a user input selecting the projected UI has been received. For example, the electronic apparatus 100 may project a guide image to display a UI on the screen. Then, the electronic apparatus 100 may identify whether the user selected the projected UI. Specifically, the electronic apparatus 100 may identify, based on the predetermined event being identified at a position of the projected UI, that the user has selected the projected UI. Here, the UI being projected may include at least one or more items. Here, the electronic apparatus 100 may perform a spatial analysis to identify whether the predetermined event is present at the position of the projected UI. Here, the electronic apparatus 100 may perform the spatial analysis through a sensor (e.g., image sensor, infrared sensor, depth camera, distance sensor, etc.). The electronic apparatus 100 may identify whether a predetermined event occurs from a specific position (position at which the UI is projected) by performing the spatial analysis. Then, based on the predetermined event being identified as occurring at the specific position (position at which the UI is projected), the electronic apparatus 100 may identify that a user input for selecting a UI corresponding to the specific position as having been received.

Specifically, the operation interface 115 may receive input of a user command for operating a multi-projection function. In an embodiment, a touch/jog icon may be provided for input of a user command through a display. Then, when the touch/jog icon is selected through a touch display and the like from among the operation interface 115, the electronic apparatus 100 may receive input of a user command (e.g., a user command for operating the multi-projection function, etc.).

The input and output interface 116 may be a configuration for inputting and outputting at least one from among an audio signal and an image signal. The input and output interface 116 may receive input of at least one from among the audio signal and the image signal from an external device, and output a control command to the external device.

According to an implementation, the input and output interface 116 may be implemented as an interface that inputs and outputs only audio signals and an interface that inputs and outputs only image signals, or implemented as one interface that inputs and outputs both the audio signals and the image signals.

Meanwhile, the input and output interface 116 according to various embodiments of the disclosure may be implemented as at least one or more wired input and output interfaces from among a High Definition Multimedia Interface (HDMI), a Mobile High-Definition Link (MHL), a Universal Serial Bus (USB), a USB C-type, a Display Port (DP), a Thunderbolt, a Video Graphics Array (VGA) port, an RGB port, a Dsubminiature (D-SUB), and a Digital Visual Interface (DVI). According to various embodiments, the wired input and output interface may be implemented as an interface that inputs and outputs only audio signals and an interface that inputs and outputs only image signals, or implemented as one interface that inputs and outputs both the audio signals and the image signals.

In addition, the electronic apparatus 100 may receive data through the wired input and output interface, but this is merely according to various embodiments, and power may be supplied through the wired input and output interface. For example, the electronic apparatus 100 may be supplied with power from an external battery through the USB C-type or supplied with power from a power outlet through a power adaptor. In still another example, the electronic apparatus 100 may be supplied with power from an external device (e.g., a notebook, a monitor, etc.) through the DP.

Meanwhile, the audio signals may be implemented to receive input through the wired input and output interface, and the image signals may be implemented to receive input through a wireless input and output interface (or communication interface). Alternatively, the audio signals may be implemented to receive input through the wireless input and output interface (or communication interface), and the image signals may be implemented to receive input through the wired input and output interface.

The speaker 117 may be a configuration for outputting audio signals. Specifically, the speaker 117 may include an audio output mixer, an audio signal processor, and a sound output module. The audio output mixer may synthesize a plurality of audio signals to be output to at least one audio signal. For example, the audio output mixer may synthesize an analog audio signal and other analog audio signals (e.g., analog audio signals received from outside) to at least one analog audio signal. The sound output module may include a speaker or an output terminal. According to various embodiments, the sound output module may include a plurality of speakers, and in this case, the sound output module may be disposed inside a main body, and at least a portion of a diaphragm of the sound output module may be covered and the radiated sound may pass a waveguide and be transferred to outside of the main body. The sound output module may include a plurality of sound output units, based on the plurality of sound output units being disposed symmetrically at an exterior of the main body, sound may be radiated to all directions, that is, 360 degrees in all directions.

The microphone 118 may be a configuration for receiving input of a user voice or other sounds and converting to audio data. The microphone 118 may receive the user voice in an activated state. For example, the microphone 118 may be integrally formed at an upper side or the front direction, a side direction, or the like of the electronic apparatus 100. The microphone 118 may include various configurations such as, for example, and without limitation, a microphone that collects the user voice in analog form, an amplifier circuit that amplifies the collected user voice, an A/D converter circuit that samples the amplified user voice and converts to a digital signal, a filter circuit that removes noise components from the converted digital signal, and the like.

The power part 119 may be supplied with power externally and supply power to various configurations of the electronic apparatus 100. The power part 119 according to various embodiments of the disclosure may be supplied with power through various methods. In various embodiments, the power part 119 may be supplied with power using a connector. In addition, the power part 119 may be supplied with power using a 220V DC power cord. However, the embodiment is not limited thereto, and the electronic apparatus 100 may be supplied with power using a USB power cord or supplied with power using a wireless charging method.

In addition, the power part 119 may receive supply of power using an internal battery or an external battery. The power part 119 according to various embodiments of the disclosure may receive supply of power through the internal battery. In an example, the power part 119 may charge power of the internal battery using at least one from among a 220V DC power cord, a USB power cord, and a USB C-Type power cord, and receive supply of power through the charged internal battery. In addition, the power part 119 according to various embodiments of the disclosure may receive supply of power through the external battery. In an example, if connection of the external battery with the electronic apparatus 10 is performed through various wired communication methods such as the USB power cord, the USB C-Type power cord, and a socket groove, the power part 119 may receive supply of power through the external battery. That is, the power part 119 may receive supply of power directly from the external battery, or charge the internal battery through the external battery and receive supply of power from the charged internal battery.

The power part 119 according to the disclosure may receive supply of power using at least one or more from among the above-described plurality of power supplying methods.

Meanwhile, with respect to power consumption, the electronic apparatus 100 may have a power consumption of less than or equal to a predetermined value (e.g., 43 W) for reasons such as a form of the socket and other standards. At this time, the electronic apparatus 100 may vary the power consumption so as to reduce power consumption when using the battery. In other words, the electronic apparatus 100 may vary the power consumption based on a power supply method, power usage, and the like.

The driving part 120 may drive at least one hardware configuration included in the electronic apparatus 100. The driving part 120 may generate physical force and transfer to the at least one hardware configuration included in the electronic apparatus 100. Here, the driving part 120 may generate drive power for a movement (e.g., movement of the electronic apparatus 100) operation of the hardware configuration included in the electronic apparatus 100.

Specifically, the driving part 120 may move a position of the electronic apparatus 100. Here, the driving part 120 may control a movement member 109 to move the electronic apparatus 100. For example, the driving part 120 may control the movement member 109 using a motor and a wheel. Meanwhile, according to the disclosure, the driving part 120 may be referred to using various terms such as, a traveling part, an operating part, a moving part, and the like.

The sensor 121 may include at least one sensor. Specifically, the sensor 121 may include at least one from among a tilt sensor that senses tilting of the electronic apparatus 100, and an image sensor that captures an image. Here, the tilt sensor may mean the acceleration sensor or the gyro sensor, and the image sensor may mean the camera or a depth camera. Meanwhile, the tilt sensor may be described as a movement sensor. In addition, the sensor 121 may include various sensors in addition to the tilt sensor or the image sensor. For example, the sensor 121 may include the illuminance sensor and a distance sensor. The distance sensor may be a Time of Flight (ToF) sensor. In addition, the sensor 121 may include a Light Detection and Ranging (LiDAR) sensor.

Specifically, the sensor 121 may obtain a sensing value for obtaining information about whether an external device is positioned within a detection range using the at least one sensor. In addition, the sensor 121 may obtain obstacle information within the detection range using the at least one sensor.

Meanwhile, the electronic apparatus 100 may control a lighting function in connection with an external device. Specifically, the electronic apparatus 100 may receive lighting information from an external device. Here, the lighting information may include at least one from among brightness information or color temperature information set in the external device. Here, the external device may mean a device connected to the same network as the electronic apparatus 100 (e.g., an IoT device included in a same home/office network) or a device that is communicable with the electronic apparatus 100 but is not in the same network as the electronic apparatus 100 (e.g., a remote control server). For example, it may be assumed that an external lighting device (IoT device) included in the same network as with the electronic apparatus 100 is outputting red light at a brightness of 50. The external lighting device (IoT device) may directly or indirectly transmit lighting information (e.g., information indicating that the red lighting is outputting at a brightness of 50) to the electronic apparatus 100. Here, the electronic apparatus 100 may control output of a light source based on lighting information received from the external lighting device. For example, when lighting information received from the external lighting device includes information about outputting red lighting at a brightness of 50, the electronic apparatus 100 may output red lighting at a brightness of 50.

Meanwhile, the electronic apparatus 100 may control the lighting function based on biometric information. Specifically, the processor 111 may obtain biometric information of the user. Here, the biometric information may include at least one from among a body temperature, number of heart rates, blood pressure, respiration, and an electrocardiogram of the user. Here, the biometric information may be included with various information in addition to the above-described information. In an example, the electronic apparatus 100 may include a sensor for measuring biometric information. The processor 111 may obtain the biometric information of the user through a sensor, and control an output of a light source based on the obtained biometric information. In another example, the processor 111 may receive the biometric information from an external device through the input and output interface 116. Here, the external device may mean a mobile communication device (e.g., a smartphone or a wearable device) of the user. The processor 111 may obtain the biometric information of the user from the external device, and control the output of the light source based on the obtained biometric information. Meanwhile, according to an implementation, the electronic apparatus 100 may identify whether the user is sleeping, and if the user is identified as sleeping (or preparing to sleep), the processor 111 may control the output of the light source based on the biometric information of the user.

Meanwhile, the electronic apparatus 100 according to various embodiments of the disclosure may provide various smart functions.

Specifically, the electronic apparatus 100 may be connected with a mobile terminal device for controlling the electronic apparatus 100 and a screen output from the electronic apparatus 100 may be controlled through a user input that is input from the mobile terminal device. In an example, the mobile terminal device may be implemented as a smartphone that includes a touch display, and the electronic apparatus 100 may receive and output, from the mobile terminal device, screen data provided from the mobile terminal device, and the screen output from the electronic apparatus 100 may be controlled according to the user input that is input in the mobile terminal device.

The electronic apparatus 100 may share content or music provided from the mobile terminal device by performing connection with the mobile terminal device through various communication methods such as, for example, and without limitation, Miracast, Airplay, wireless DEX, remote PC method, and the like.

Then, the mobile terminal device and the electronic apparatus 100 may have connection performed in various connection methods. In various embodiments, the mobile terminal device may search the electronic apparatus 100 and perform wireless connection, or the electronic apparatus 100 may search the mobile terminal device and perform wireless connection. Then, the electronic apparatus 100 may output content provided from the mobile terminal device.

In various embodiments, when a predetermined gesture (e.g., a motion tap view) is detected through a display of the mobile terminal device after the mobile terminal device is positioned near the electronic apparatus 100 while a specific content or music is being output from the mobile terminal device, the electronic apparatus 100 may output content or music being output from the mobile terminal device.

In various embodiments, when the mobile terminal device becomes close with the electronic apparatus 100 by less than or equal to a predetermined distance (e.g., a non-contact tap view) or the mobile terminal device is contacted twice with the electronic apparatus 100 at short intervals (e.g., contact tap view) while a specific content or music is being output from the mobile terminal device, the electronic apparatus 100 may output content or music being output from the mobile terminal device.

In the above-described embodiment, a screen same as the screen being provided in the mobile terminal device has been described as being provided in the electronic apparatus 100, but the disclosure is not limited thereto. In other words, when connection between the mobile terminal device and the electronic apparatus 100 is established, a first screen provided from the mobile terminal device may be output from the mobile terminal device, and a second screen provided from the mobile terminal device that is different from the first screen may be output from the electronic apparatus 100. In an example, the first screen may be a screen provided by a first application installed in the mobile terminal device, and the second screen may be a screen provided by a second application installed in the mobile terminal device. In an example, the first screen and the second screen may be screens different from each other provided by one application installed in the mobile terminal device. In addition, in an example, the first screen may be a screen that includes a remote controller type UI to control the second screen.

The electronic apparatus 100 according to the disclosure may output a standby screen. In an example, if connection of the electronic apparatus 100 with an external device is not performed or if no input is received from an external device for a predetermined time, the electronic apparatus 100 may output a standby screen. Conditions for the electronic apparatus 100 to output the standby screen is not limited to the above-described examples and the standby screen may be output by various conditions.

The electronic apparatus 100 may output a standby screen of a blue screen form, but the disclosure is not limited thereto. In an example, the electronic apparatus 100 may obtain an atypical object by extracting only the form of a specific object from data received from the external device, and output a standby screen including the obtained atypical object.

Meanwhile, the electronic apparatus 100 may further include a display (not shown).

The display (not shown) may be implemented as displays of various forms such as, for example, and without limitation, a liquid crystal display (LCD), an organic light emitting diode (OLED) display, a plasma display panel (PDP), and the like. In the display (not shown), a driving circuit, which may be implemented in a form of an amorphous silicon thin film transistor (a-si TFT), a low temperature poly silicon (LTPS) TFT, an organic TFT (OTFT), and the like, a backlight unit, and the like may be included. Meanwhile, the display (not shown) may be implemented as a touch screen coupled with a touch sensor, a flexible display, a three-dimensional display (3D display), and the like. In addition, according to various embodiments of the disclosure, the display (not shown) may include not only a display panel that outputs an image, but also a bezel which houses a display panel. Specifically, according to various embodiments of the disclosure, the bezel may include a touch sensor (not shown) for detecting user interaction.

Meanwhile, the electronic apparatus 100 may further include a shutter part (not shown).

The shutter part (not shown) may include at least one from among a shutter, a fixed member, a rail or a body.

Here, the shutter may block light being output from the projection part 112. Here, the fixed member may fix the position of the shutter. Here, the rail may be a path for moving the shutter and the fixed member. Here, the body may be a configuration that includes the shutter and the fixed member.

The processor 111 may be implemented as a digital signal processor (DSP) for processing digital signals, a microprocessor, or a time controller (TCON). However, the embodiment is not limited thereto, and may include one or more from among a central processing unit (CPU), a micro controller unit (MCU), a micro processing unit (MPU), a controller, an application processor (AP), a graphics-processing unit (GPU) or a communication processor (CP), or an advanced reduced instruction set computer (RISC) machines (ARM) processor, or may be defined by a relevant term. In addition, the processor 111 may be implemented as a System on Chip (SoC) or a large scale integration (LSI) in which a processing algorithm is embedded, and may be implemented in a form of a field programmable gate array (FPGA). In addition, the processor 111 may perform various functions by executing computer executable instructions stored in the memory 113.

Specifically, the processor 111 may receive, by executing at least one instruction stored in the memory 113, information about an edited projection area corresponding to an edited UI element from the terminal device based on receiving a user input for editing the UI element corresponding to the projection area through the terminal device, and project a moving image based on a projection angle and a projection position obtained through information about the edited projection area.

In one or more embodiments, the processor 111 may receive an image which captured one area from the terminal device, and transmit information about at least one projection candidate area from among the background area corresponding to objects included in the received image to the terminal device.

In one or more embodiments, the processor 111 may receive, based on receiving a user input corresponding to at least one home from among a size, a form, or a position of the UI element through the terminal device that outputs the UI element corresponding to the projection area within the projection candidate area, information about the edited projection area corresponding to the edited UI element from the terminal device, and project a mobbing image based on the projection angle and the projection position obtained through information about the edited projection area.

In one or more embodiments, the processor 111 may transmit, based on an obstacle being present in a surrounding of the projection position corresponding to projection of the edited projection area, data corresponding to at least one substitute position for the projection position to the terminal device, and project a moving image from the substitute position corresponding to a selected option based on receiving a user input corresponding to data transmitted through the terminal device.

In one or more embodiments, the processor 111 may identify an area of a minimum size or more to which the moving image is projectable as the projection candidate area from among the background area corresponding to objects included in the received image.

In one or more embodiments, the processor 111 may move to a position corresponding to one area based on an image and 3D map data.

In one or more embodiments, the processor 111 may transmit, based on projecting the moving image from the projection part, information about the projection area to which the moving image is projected to the terminal device.

In one or more embodiments, the processor 111 may receive, based on receiving a user input corresponding to at least one editing from among a size, a form, or a position of the UI element through the terminal device that outputs the UI element corresponding to the projection area to which the moving image is projected in the image that captured the projection area, information about the edited projection area corresponding to the edited UI element from the terminal device, and project the moving image based on the projection angle and the projection position obtained through the information about the edited projection area.

In one or more embodiments, the processor 111 may transmit, based on an obstacle being present in the surrounding of the projection position corresponding to projection of the edited projection area, data corresponding to at least one substitute position for the projection position to the terminal device, and project, based on receiving a user input corresponding to the data transmitted through the terminal device, a moving image from the substitute position corresponding to the user input.

In one or more embodiments, the processor 111 may project, based on not receiving a following user input corresponding to editing of the UI element for a predetermined time or more while the UI element is being edited through the terminal device, the moving image based on the projection angle and the projection position obtained through information about the edited projection area.

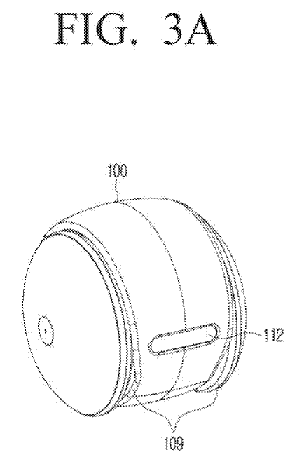

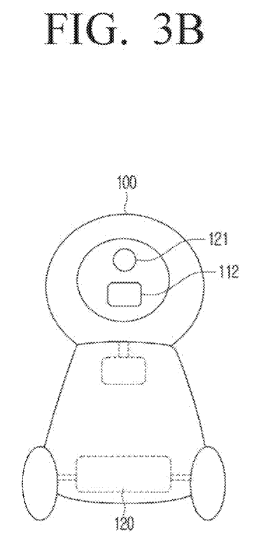

FIG. 3A and FIG. 3B are diagrams illustrating an exterior of the electronic apparatus 100 according to various embodiments of the disclosure.

Referring to the embodiment of FIG. 3A, the electronic apparatus 100 may include the movement member 109. The movement member 109 may mean a member for moving from a first position to a second position in a space in which the electronic apparatus 100 is disposed. The electronic apparatus 100 may control the movement member 109 for the electronic apparatus 100 to be moved using force generated from the driving part 120. At this time, the movement member 109 may include a motor or a wheel. In addition, the electronic apparatus 100 may include the projection part 112 on one area of the main body as shown in FIG. 3B.

Referring to FIG. 3B, the electronic apparatus 100 may include the sensor 121 and the projection part 112 at a head area. Here, the head area may mean an area positioned at an upper end of the electronic apparatus 100, and may be referred to in various terms such as, for example, and without limitation, an upper end area, a top area, a detection area, a projection area, and the like. Further, the head area of the electronic apparatus 100 may adjust the projection angle or may be rotated to sense information about the surrounding of the electronic apparatus 100. At this time, the head area of the electronic apparatus 100 may be rotated by the rotation part as shown in FIG. 3. In one or more embodiments, the head area of the electronic apparatus 100 may perform a yaw rotation rotating in left and right directions. In addition, the head area of the electronic apparatus 100 may perform a pitch rotation rotating in top and bottom directions. In addition, the head area of the electronic apparatus 100 may perform a roll rotation rotating in clockwise/anti-clockwise directions. However, although the head area of the electronic apparatus 100 may rotate in all three axis directions, this is merely one embodiment, and may rotate in only a portion of the directions from among the three axis directions.

In addition, at a lower end area of the electronic apparatus 100, the driving part 120 may be included. The driving part 120 may move the electronic apparatus 100 by driving the movement member (i.e., wheel).

In other words, the electronic apparatus 100 may adjust the projection angle of the electronic apparatus 100 through the rotation part, and adjust the projection position of the electronic apparatus 100 through the driving part 120.

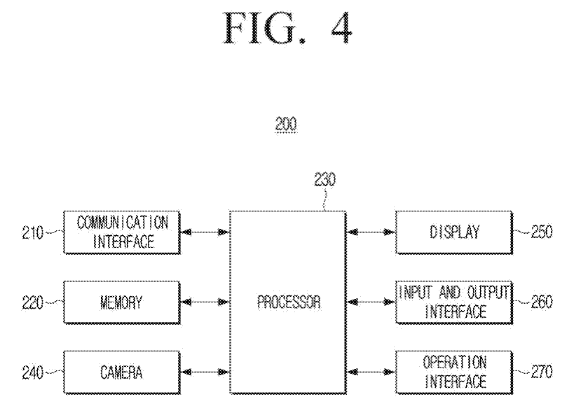

FIG. 4 is a block diagram illustrating a configuration of a terminal device 200 according to an embodiment of the disclosure.

Configurations shown in FIG. 4 are merely various embodiments, and a portion of the configurations may be omitted and a new configuration may be added. As shown in FIG. 4, the terminal device 200 may include a communication interface 210, a memory 220, a processor 230, a camera 240, a display 250, an input and output interface 260, and an operation interface 270. The configurations shown in FIG. 4 area merely one embodiment, and a portion of the configuration may be omitted or added according to a configuration of the terminal device 200. Meanwhile, because detailed examples of the communication interface 210, the memory 220, the processor 230, the display 250, the input and output interface 260, and the operation interface 270 have been described above, redundant descriptions thereof will be omitted.

The communication interface 210 may transmit a captured image to the electronic apparatus 100, or receive information about the projection candidate area or information about a current projection area from the electronic apparatus 100. In addition, the communication interface 210 may transmit information about the edited projection area to the electronic apparatus 100.

The memory 220 may store the captured image or store information about the current projection area. In addition, the memory 220 may store information about the edited projection area.

The processor 230 may transmit the captured image or information about the UI element to the electronic apparatus 100, or control the communication interface 210 to receive information about the projection candidate area or information about the current projection area from the electronic apparatus 100. In addition, the processor 230 may control the display 250 to display a UI element corresponding to a user input for editing the UI element.

The camera 240 may capture an image and a moving image. The camera 240 may be implemented as cameras of various forms such as, for example, and without limitation, a depth camera, a stereo camera, an AI camera, an infrared camera, a motion camera, and the like. The camera 240 may include one or more image sensors (e.g., front surface sensor or a back surface sensor), a lens, an image signal processor (ISP), or a flash (e.g., LED or xenon lamp, etc.).

Specifically, the camera 240 may obtain an image of an area for projecting the moving image by the electronic apparatus 100. At this time, the obtained image may include one or more objects. The objects may be objects of various types such as, for example, and without limitation, people, animals, furniture, electronic devices, and the like.

The display 250 may display various information. Specifically, the display 250 may display an image of an area for projecting the moving image. The display 250 may display the projection candidate area and the UI element included in the image.

FIG. 4 is shows the display being included in the terminal device 200, but is not necessarily limited thereto, and image or video signals may be transmitted to an external display that is connected with the terminal device 200 through the input and output interface 260 so as to be output. The terminal device 200 will be described as displaying the UI element through the display 250 included in the terminal device 200 below.

The operation interface 270 may receive input of a user interaction. The input and output interface 260 may receive input of interaction for editing a UI element from the user.

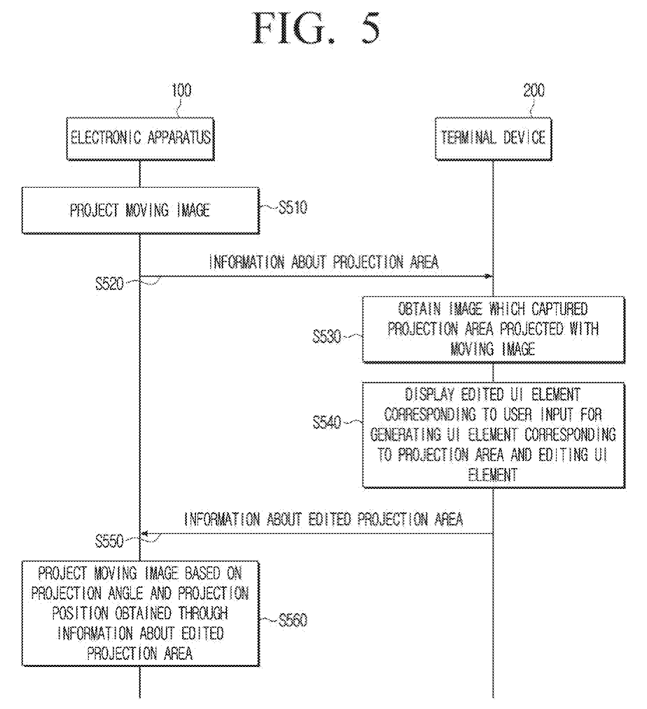

FIG. 5 is a flowchart illustrating a method for editing the projection area 10 while the electronic apparatus 100 is projecting a moving image according to an embodiment of the disclosure.

The processor 111 may control the projection part 112 to project the moving image onto the projection area 10 (S510). The projection area 10 may mean an area to which the moving image is projected by the electronic apparatus 100 on a wall surface or a ceiling, or the like. The processor 111 may receive the moving image from the terminal device 200 through the communication interface 114, and control the projection part 112 to project the received moving image onto the projection area 10.

The processor 111 may transmit, based on projecting the moving image from the projection part 112, information about the projection area 10 to which the moving image is projected to the terminal device 200 through the communication interface 114 (S520). Information about the current position area 10 may include information about a size, a position, a rotation, a tilt, and a projection position of the projection area 10. The size of the projection area 10 may mean horizontal and vertical lengths of the projection area 10 to which the moving image is projected. The position of the projection area 10 may be the position of the projection area 10 to which the moving image is projected on a wall surface. The rotation of the projection area 10 may mean a degree to which the projection area 10 is rotated horizontally or vertically. The projection position may be the position of the electronic apparatus 100 for projecting the moving image onto the projection area 10.

The terminal device 200 may obtain an image 30 which captured the projection area 10 to which the moving image is projected through the camera 240 by the user (S530). The image 30 which captured the projection area 10 may be an image 30 of an area that includes the projection area 10 and the wall surface to which the moving image is projected. Alternatively, the image 30 which captured the projection area 10 may be a moving image that captures in real-time an area that includes the projection area 10 and the wall surface.

The terminal device 200 may control the display 250 to display the edited UI element corresponding to the user input for editing the UI element 20 while generating and displaying the UI element 20 corresponding to the projection area 10 to which the moving image is projected in the image 30 which captured the projection area 10 (S540). Specifically, the terminal device 200 may overlay and display the UI element 20 having a size and shape that corresponds to the projection area 10 included in the image 30 that captured the projection area 10 over the projection area 10. At this time, the terminal device 200 may display the UI element 20 based on the image 30 that captured the projection area 10 and information about the projection area 10. The terminal device 200 may match information about the UI element 20 displayed in the image 30 that captured the projection area 10 and information about the projection area 10 and store the same in the memory 113.

The terminal device 200 may display the edited UI element based on receiving the user input for editing the UI element 20 while displaying the UI element 20 corresponding to the current projection area 10 in the image 30 that captured the current projection area 10. Specifically, based on receiving a user input for at least one editing from among the size, the form, or the position of the UI element 20, the terminal device 200 may display the UI element with at least one from among the size, the form, or the position edited.

The terminal device 200 may control the display 250 to display the UI element edited by the user input for editing the UI element.

The terminal device 200 may store information about the edited projection area corresponding to the edited UI element in the memory 220. The information about the edited projection area corresponding to the edited UI element may include information about the UI element 20 corresponding to the current projection area 10 and information about the edited UI element. In an example, the terminal device 200 may store the UI element 20 corresponding to the current projection area 10 and information about the size, the form, and the position of the edited UI element. The terminal device 200 may store information about a difference with the UI element 20 corresponding to the current projection area 10 for at least one from among the size, the position, the rotation, and the tilt of the edited UI element.

The processor 111 may receive the information about the edited projection area corresponding to the edited UI element from the terminal device 200 through the communication interface 114 (S550).

The processor 111 may control at least one from among the driving part 120 and the projection part 112 to project the moving image based on the projection angle and the projection position obtained through the information about the edited projection area (S560). Specifically, the processor 111 may control the driving part 120 to move to the projection position obtained based on the information about the edited projection area, and control the projection part 112 to project the moving image at a projection angle obtained based on information about the edited projection area.

The processor 111 may obtain the projection angle and the projection position of the electronic apparatus 100 through information about the edited projection area.

In one embodiment, the processor 111 may obtain information about a difference between the edited UI element and the UI element 20 corresponding to the current projection area 10. Specifically, the processor 111 may obtain information about a difference with the UI element 20 corresponding to the current projection area 10 for at least one from among the size, the position, the rotation, and the tilt of the edited UI element.

The processor 111 may identify an edited projection area 11 corresponding to the edited UI element based on information about the edited UI element. Specifically, the processor 111 may identify the edited projection area 11 corresponding to the edited UI element based on a difference between the edited UI element and the UI element 20 corresponding to the current projection area 10. The processor 111 may identify the edited projection area 11 corresponding to the edited UI element by reflecting the difference between the edited UI element and the UI element 20 corresponding to the current projection area 10 in the information about the current projection area 10.

In still another embodiment, the processor 111 may identify the edited projection area 11 corresponding to the edited UI element based on information about a difference between the edited UI element received from the terminal device 200 and the UI element 20 corresponding to the current projection area 10. The processor 111 may identify the edited projection area 11 corresponding to the edited UI element by reflecting the difference between the edited UI element and the UI element 20 corresponding to the current projection area 10 in the information about the current projection area 10.

The processor 111 may obtain the projection position and the projection angle for projecting the moving image onto the edited projection area 11 corresponding to the edited UI element.

The processor 111 may control at least one from among the driving part 120 and the projection part 112 to projecting the moving image based on the obtained projection angle and projection position.

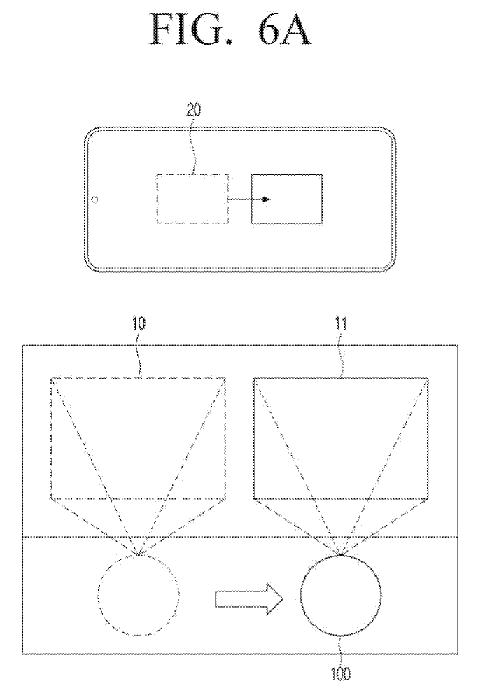

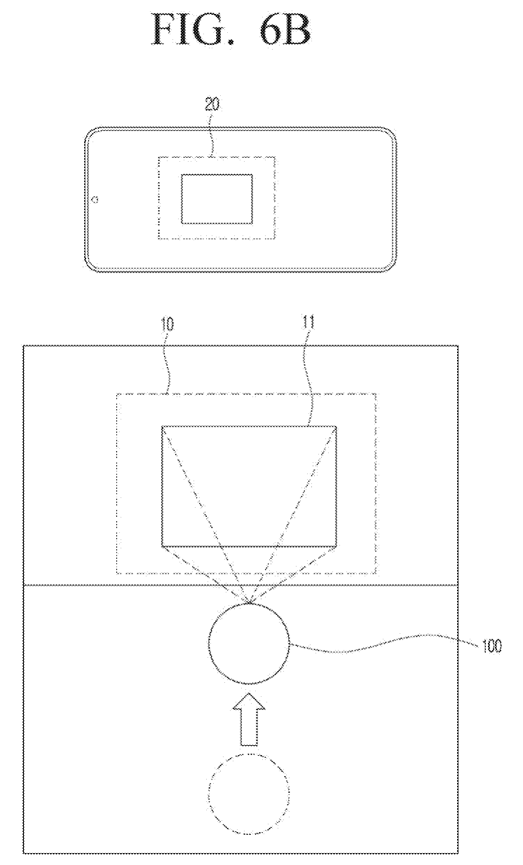

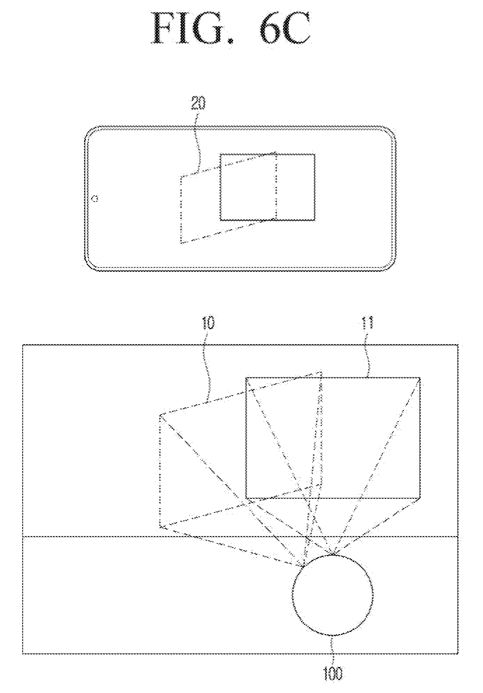

FIG. 6A to FIG. 6C are diagrams illustrating an operation of the electronic apparatus 100 according to a user input for editing a UI element in the terminal device 200 according to an embodiment of the disclosure.

Referring to FIG. 6A, the terminal device 200 may receive a user input corresponding to interaction for changing the position of the UI element 20 from the user. The terminal device 200 may change and display the position of the UI element 20 to correspond to a movement direction and movement distance of a dragging interaction when an interaction of touching and dragging the UI element is received from the user. Specifically, the terminal device 200 may identify the movement direction and movement distance of the dragging interaction based on a position of a point touched by the user and a position of a point after dragging is completed.

The terminal device 200 may store information about the edited projection area 11 corresponding to the UI element that changed position by the dragging interaction in the memory 220. The information about the edited projection area corresponding to the UI element that changed position may include information about the movement direction and movement distance of the dragging interaction.

The terminal device 200 may transmit information about the edited projection area corresponding to the UI element that changed position by the dragging interaction to the electronic apparatus 100.

The processor 111 may control at least one from among the driving part 120 and the projection part 112 to project the moving image based on the projection angle and projection position obtained through the information about the edited projection area 11 received. Specifically, the processor 111 may control at least one from among the driving part 120 and the projection part 112 to project the moving image based on the projection angle and the projection position obtained through information about the movement direction and movement distance of the dragging interaction. In an example, if the movement direction of the dragging interaction is in a horizontal direction, the processor 111 may control the driving part 120 to move in a direction corresponding to the movement direction while maintaining a projection distance between the electronic apparatus 100 and the projection surface. In addition, the processor 111 may control the driving part 120 to move by a distance corresponding to the movement distance from the current projection position. In still another example, if the movement direction of the dragging interaction is in a vertical direction, the processor 111 may control the projection part 112 to adjust the projection angle by rotating the electronic apparatus 100 in the top and bottom directions corresponding to the movement direction. Alternatively, the processor 111 may control the driving part 120 to become closer or farther than the projection distance between the electronic apparatus 100 and the projection surface, and control the projection part 112 to adjust the projection angle by rotating in the top and bottom directions. However, the above is merely one embodiment, and if the movement direction of the dragging interaction includes both the horizontal direction and the vertical direction, the above-described operations may all be carried out.

Referring to FIG. 6B, the terminal device 200 may receive a user input corresponding to an interaction for changing the size of the UI element 20 from the user. The terminal device 200 may change and display, based on receiving input of a pinch out interaction for increasing the size of the UI element 20 or receiving input of a pinch in interaction for reducing the size of the UI element 20 from the user, the size of the UI element 20 to correspond to the pinch out interaction or the pinch in interaction. Specifically, the terminal device 200 may increase or reduce the size of the UI element according to a distance ratio between two points before and after the interaction and display the same based on receiving input of the pinch out interaction of increasing the distance between two points while touching the two points of the UI element 20 or the pinch in interaction of reducing the distance between the two points from the user.

The terminal device 200 may store information about the edited projection area 11 corresponding to the UI element that changed size by the pinch out interaction or pinch in interaction in the memory 220. The information about the edited projection area 11 corresponding to the UI element that changed size may include a ratio of a distance between two points before and after the interaction.

The terminal device 200 may transmit the information about the edited projection area 11 corresponding to the UI element that changed size by the pinch out interaction or pinch in interaction to the electronic apparatus 100.

The processor 111 may control at least one from among the driving part 120 and the projection part 112 to project the moving image based on the projection angle and projection position obtained through the information about the edited projection area 11 that was received. Specifically, the processor 111 may control at least one from among the driving part 120 and the projection part 112 to project the moving image based on the projection angle and projection position obtained through a ratio of a distance between the two points before and after the interaction. The processor 111 may control the driving part 120 to move by increasing or reducing the projection distance between the electronic apparatus 100 and the projection surface based on the ratio of the distance between the two points before and after the interaction.

Referring to FIG. 6C, the terminal device 200 may receive a user input corresponding to an interaction for changing the tilt of the UI element 20 from the user. If the projection surface is tilted, there may be a distortion at the projection area to which the electronic apparatus 100 projects the moving image. The terminal device 200 may receive a user input corresponding to an interaction that changes the tilt of the UI element 20 for obtaining a projection area without distortion. The terminal device 200 may receive a user input corresponding to an interaction for changing a form of the UI element 20 to correspond to a tilt of a wall surface from the user. In an example, the terminal device 200 may change the form of the UI element 20 by receiving input of an interaction of dragging after having touched one point of the UI element 20 for a predetermined time or more from the user.

The terminal device 200 may store information about the edited projection area 11 corresponding to the UI element that changed form by the interaction for changing the tilt in the memory 220.

The terminal device 200 may transmit information about the edited projection area 11 corresponding to the UI element that changed form to the electronic apparatus 100.

The processor 111 may control at least one from among the driving part 120 and the projection part 112 to project the moving image based on the projection angle and projection position obtained through the information about the edited projection area 11 that was received. Specifically, the processor 111 may control the projection part 112 to adjust the projection angle by rotating the top and bottom directions or the left and right directions.

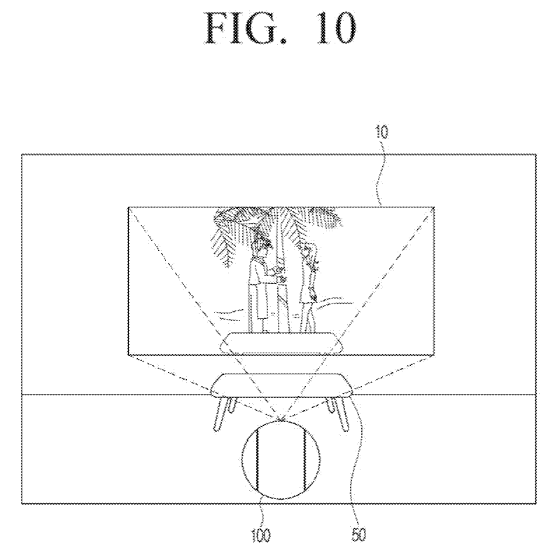

Meanwhile, the electronic apparatus 100 may not be able move to the projection position corresponding to the projection of the projection area 10. Specifically, the electronic apparatus 100 may not be able to move to the projection position due to obstacles such as furniture being present at the projection position corresponding to the projection of the projection area 10. Descriptions associated therewith will be described in detail in FIG. 10.

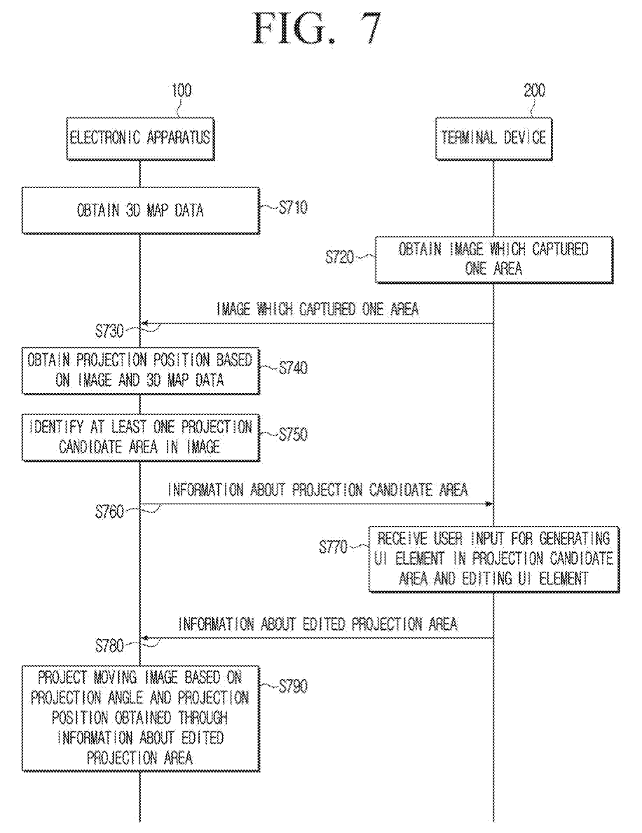

FIG. 7 is a flowchart illustrating an operation of the electronic apparatus 100 and the terminal device 200 if there is 3D map data according to an embodiment of the disclosure.

The processor 111 may obtain 3D map data (S710). The 3D map data may be a map including information about wall surfaces and objects that are included in a space in which the electronic apparatus 100 is used. The 3D map data may include information about edges and obstacles on the image 30. In addition, the 3D map data may include information about a projection candidate area 40. At this time, the information about the projection candidate area 40 may include information about a size of the projection candidate area 40 or a number of projection candidate area 40 present on a wall surface.

The processor 111 may generate 3D map data using a plane diagram of a space in which the electronic apparatus 100 is used. Alternatively, the processor 111 may generate 3D map data of a space in which the electronic apparatus 100 is positioned using a plurality of images 30 captured through the camera 240. In still another embodiment, the processor 111 may receive 3D map data of a space in which the electronic apparatus 100 is used from an external server. The processor 111 may store 3D map data of the space in which the electronic apparatus 100 is used in the memory 113.

The terminal device 200 may obtain the image 30 which captured one area (S720). The terminal device 200 may obtain the image 30 of one area of a space in which the electronic apparatus 100 is used through the camera 240. At this time, the one area of the space in which the electronic apparatus 100 is used (otherwise, referred to as ‘one area’) may be a wall surface for projecting the moving image. The one area of the space may be an area for projecting the moving image by the user from among a plurality of wall surfaces included in the space in which the electronic apparatus 100 is used. The captured image 30 may be a picture or a moving image. The terminal device 200 may store information about a space in which the image 30 is obtained in the memory 113. The information about a space may include information about a position of the terminal device 200.

The processor 111 may receive the image 30 that captured one area of the space in which the electronic apparatus 100 is positioned from the terminal device 200 through the communication interface 114 (S730). The electronic apparatus 100 may receive the image 30 together with information about the space with the obtained image 30 through the communication interface 114.

The processor 111 may obtain the projection position corresponding to one area of the space based on the image 30 and 3D map data (S740). The projection position corresponding to one area of a space may be a position for projecting the moving image at one area. If the user captured one wall surface included in the space in which the electronic apparatus 100 is used, the projection position corresponding to the one area of the space may be a position for projecting the moving image onto the wall surface. The processor 111 may obtain the projection position by comparing information about the projection candidate area 40 included in the 3D map data and information about the projection candidate area 40 on the image 30.

The processor 111 may control the driving part 120 to move to a position corresponding to one area based on the image and the 3D map data.

The processor 111 may control the driving part 120 to move to the obtained projection position even if information about the edited UI element is not yet received from the terminal device 200. Through the above, the electronic apparatus 100 may show the user the projection area 10 that is changed in real-time according the edited UI element 20 by projecting the moving image onto the corresponding projection area 10 while the user is editing the UI element.

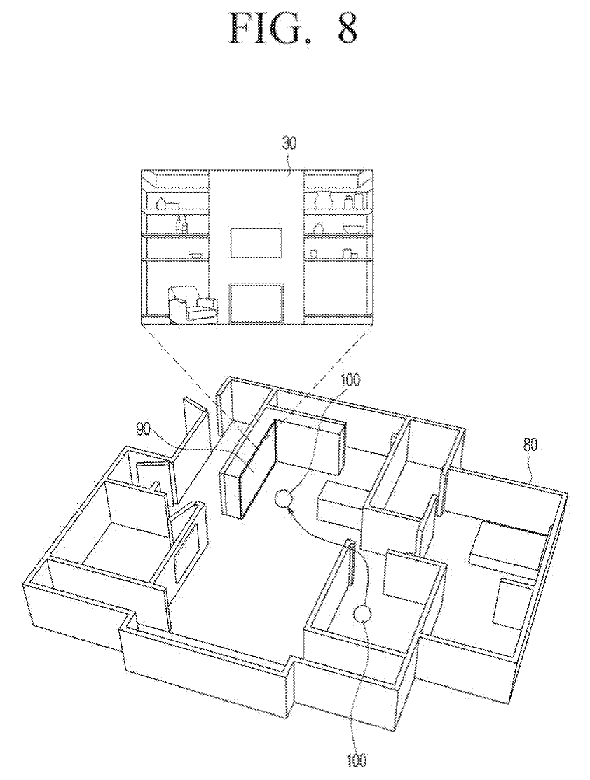

FIG. 8 is a diagram illustrating the electronic apparatus 100 moving based on 3D map data and an image 30 according to an embodiment of the disclosure.

Referring to FIG. 8, the terminal device 200 may obtain the image 30 of one area 90 of a space being used. The electronic apparatus 100 may obtain the projection position corresponding to the one area 90 of the space based on the image 30 and 3D map data. The electronic apparatus 100 may obtain the projection position corresponding to the one area 90 of the space by comparing information about a space included in the 3D map data and information included in the image 30. The electronic apparatus 100 may move to the obtained projection position.

Meanwhile, the processor 111 may correct a tilt of the image 30 received from the terminal device 200. The electronic apparatus 100 may identify, when identifying the projection area 10 based on the image 30 in which the terminal device 200 and the wall surface are not parallel, the projection area 10 under the premise that the wall surface is tilted by an angle formed by the terminal device 200 and the wall surface. To prevent the above, the processor 111 may correct the tilt of the image 30 received from the terminal device 200. The processor 111 may correct the tilt of the image 30 based on the angle formed by the wall surface and the terminal device 200 that is measured through the sensor 121 in the terminal device. Specifically, the processor 111 may obtain an image that is tilted in opposite by the angle between the wall surface and the terminal device 200.

Referring to FIG. 7, the processor 111 may identify information about at least one projection candidate area 40 from among the background area corresponding to the objects included in the image 30 (S750). The processor 111 may identify an area of a minimum size or more to which the moving image is projectable as the projection candidate area 40 from among the background area corresponding to the objects included in the image 30. The processor 111 may identify an edge which is a boundary of an object included in the image 30 and identify an area between the edges as the background area. The processor 111 may identify an area of a minimum size or more to which the moving image is projectable as the projection candidate area 40 from among the area between the edges.

Meanwhile, an operation for identifying the projection candidate area 40 in the image 30 may be performed by the terminal device 200 or the external device. The terminal device 200 may identify the edge which is the boundary of the object included in the captured image 30 and the background area which is the area between the edges. The terminal device 200 may identify an area of a minimum size or more to which the moving image is projectable as the projection candidate area 40 from among the background area and display on the display 250j.

In still another embodiment, the terminal device 200 may transmit the captured image 30 to the external device. The terminal device 200 may receive information about the identified projection candidate area 40 from the external device and display on the display 250.

The processor 111 may transmit information about at least one projection candidate area 40 to the terminal device 200 through the communication interface 114 (S760). The processor 111 may identify the at least one projection candidate area 40 included in the image 30, and transmit information about the identified at least one projection candidate area 40 to the terminal device 200 through the communication interface 114.

The terminal device 200 may overlay and display the received projection candidate area 40 over the image 30.

The terminal device 200 may generate and display the UI element 20 corresponding to the projection area 10 within the at least one projection candidate area 40 included in the image. The UI element 20 corresponding to the projection area 10 may be the UI element 20 for displaying the projection area 10 to project the moving image within the projection candidate area 40. The terminal device 200 may generate and display the UI element 20 having a predetermined size within the projection candidate area 40 according to the user input. Alternatively, the terminal device 200 may generate and display the UI element 20 having a size set by the user within the projection candidate area 40 according to the user input. The terminal device 200 may visually check in advance with the user about the projection area 10 to which the moving image is projected by displaying the UI element 20 corresponding to the projection area 10.

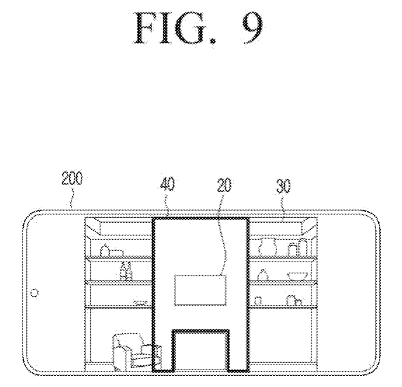

FIG. 9 is a diagram illustrating the projection candidate area 40 included in the captured image 30 and the UI element 20 according to an embodiment of the disclosure.

Referring to FIG. 9, the terminal device 200 is displaying the image 30 which captured the wall surface that is one area of the space in which the electronic apparatus 100 is used. At both sides of the wall surface, there are shelves, and objects such as ceramics and frames are placed on top of the shelves. The processor 111 may identify the edges which are boundaries of the objects such as the shelves, the ceramics, and the frames in the image 30. The processor 111 may identify an area between the edges as the background area. The background area in FIG. 9 may be an empty space at a center of the wall surface and a space between the shelves at both sides thereof and the edges of objects placed on top of the shelves. The processor 111 may identify the projection candidate area 40 which is an area of a minimum size or more to which the moving image is projectable from among the background area. Referring to FIG. 9, the processor 111 may identify the empty space present at the center of the wall surface as the projection candidate area 40. The processor 111 may transmit the information about the projection candidate area 40 to the terminal device 200 through the communication interface 114. The terminal device 200 may overlay and display the received projection candidate area 40 over the image 30. The terminal device 200 may generate and display the UI element 20 corresponding to the projection area 10 within at least one projection candidate area 40 included in the image 30.

Referring to FIG. 7, the terminal device 200 may receive the user input for editing the UI element 20 (S770). Specifically, the terminal device 200 may receive an input for at least one editing from among the size, the form, or the position of the UI element 20 from the user. For example, the terminal device 200 may receive an input corresponding to an interaction for increasing or reducing the size of the UI element 20 from the user. In an example, the terminal device 200 may receive an input corresponding to the pinch out interaction for increasing the size of the UI element or receive an input corresponding to the pinch in interaction for reducing the size of the UI element 20 from the user.

In another example, the terminal device 200 may receive an input corresponding to an interaction for changing the form of the UI element 20 from the user. Specifically, the terminal device 200 may receive an input corresponding to an interaction for changing the form of the UI element 20 so as to correspond to a tilt of the projection area 10 from the user. If the wall surface to project the moving image is titled, the electronic apparatus 100 may project the moving image to correspond to the tilt of the wall surface. The terminal device 200 may receive an input corresponding to an interaction for changing the tilt of the UI element 20 so as to correspond to the tilt of the wall surface from the user. For example, the terminal device 200 may change the form of the UI element 20 by receiving an input corresponding to an interaction of dragging one edge of the UI element 20 from the user.

In another example, the terminal device 200 may receive an input corresponding to an interaction for changing the position of the UI element 20 from the user. The terminal device 200 may change the position of the UI element 20 to correspond to the movement direction of the dragging interaction by receiving the input corresponding to the interaction of touching and dragging the UI element 20 from the user.

The processor 111 may receive information about the edited projection area 11 corresponding to the UI element edited by the user input for editing the UI element from the terminal device 200 through the communication interface 114 (S780). Specifically, the processor 111 may receive information about the edited projection area 11 corresponding to the UI element edited by the user input for editing at least one from among the size, the form, and the position of the UI element 20 from the terminal device 200 through the communication interface 114. At this time, the information about the edited projection area 11 may include relative information between the projection candidate area 40 included in the image 30 and the edited UI element. At this time, the relative information between the projection candidate area 40 and the edited UI element may be relative information of the size and position between the projection candidate area 40 and the UI element 20.

The processor 111 may control at least one from among the driving part 120 and the projection part 112 to project the moving image based on the projection angle and projection position obtained through information about the edited projection area 11 (S790). Specifically, the processor 111 may control the driving part 120 to move to the projection position obtained through the information about the edited projection area 11, and control the projection part 112 to project the moving image at the projection angle obtained through the information about the edited projection area 11.

The processor 111 may identify the edited projection area 11 corresponding to the edited UI element based on relative information of the edited UI element and 3D map data stored in the memory 113. The processor 111 may identify information corresponding to the projection candidate area 40 included in the image 30 from the 3D map data. The processor 111 may identify the edited projection area 11 corresponding to the edited UI element by reflecting relative information of the edited UI element for the projection candidate area 40 included in the 3D map data.

The processor 111 may obtain the projection position and projection angle through information about the edited projection area 11.

The processor 111 may control the driving part 120 to move to the projection position to project the moving image onto the projection area 11 corresponding to the edited UI element, and control the projection part 112 to project the moving image to a projection pose corresponding to the projection area 10. Specifically, the processor 111 may control the projection part 112 to adjust the projection direction or the projection angle.

FIG. 10 is a diagram illustrating an example of an obstacle being present in a surrounding of a projection position according to an embodiment of the disclosure.

The processor 111 may transmit, based on an obstacle being present in the surrounding of the projection position corresponding to the projection of the edited projection area 11, data corresponding to at least one substitute position for the projection position to the terminal device 200 through the communication interface 114.

The electronic apparatus 100 may not project the moving image from the projection position corresponding to the projection of the projection area 10. Specifically, the electronic apparatus 100 may not be able to move to the projection position due to an obstacle such as furniture being present at the projection position corresponding to the projection of the projection area 10. Alternatively, the electronic apparatus 100 may be able to move to the projection position, but there may be interference with projection due to obstacles such as furniture being present between the electronic apparatus 100 and the wall surface. Referring to FIG. 10, an example of a portion of the projection area 10 not being projected due to projection being interfered by a table 50 positioned between the electronic apparatus 100 and the wall surface is shown.

The processor 111 may identify at least one substitute position for the projection position.

The processor 111 may project the moving image from a substitute position at which changes in size or position, brightness, and the like of the projection area 10 can be minimized. The processor 111 may project the moving image from a substitute position near the projection position corresponding to the projection of the projection area 10.

Alternatively, the processor 111 may project to an area that corresponds to the size or position of the projection area 10 through correction while projecting the moving image from a position farther from the projection surface than the projection position corresponding to the edited projection area 11. Alternatively, the processor 111 may project by changing the projection method. Specifically, the processor 111 may change from a typical projection method to a UST projection method and project the projection pose for projecting the moving image onto the projection area 10 and the moving image from the projection position in the UST projection method.

The processor 111 may store data corresponding to at least one substitute position in the memory 113. The processor 111 may store the projection position and projection pose for projecting the moving image from the at least one substitute position in the memory 113.

The processor 111 may transmit data corresponding to at least one substitute position to the terminal device 200 through the communication interface 114.

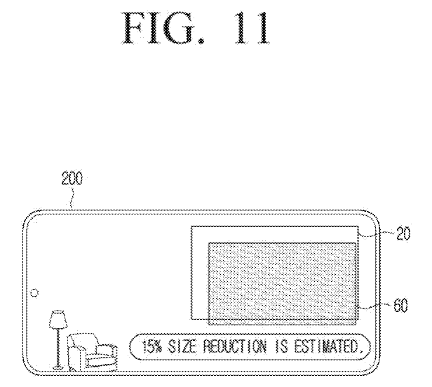

FIG. 11 is a diagram illustrating an option for being displayed in the terminal device 200 according to an embodiment of the disclosure.

The terminal device 200 may display at least one option corresponding to at least one substitute position. Referring to FIG. 11, the terminal device 200 may display the UI element 20 corresponding to the projection area 10 and a UI element 60 corresponding to a substitute projection area for projecting the moving image from the substitute position. At this time, the terminal device 200 may display a description on an option together with the UI element 60 corresponding to the substitute projection area. FIG. 11 shows an example of the terminal device 200 in which the UI element 60 corresponding to the substitute projection area is displayed smaller than the UI element 20 corresponding to the projection area 10 and a description of an option ‘15% size reduction is estimated’ being displayed.

At this time, if there is a plurality of options for projecting the moving image from the substitute positions, the terminal device 200 may display the UI element 60 corresponding to the plurality of options, respectively. For example, the terminal device 200 may display a UI element (e.g., a UI element in which letters of option 1 and option 2 are written) in which a plurality of options is selectable, and when a UI element (e.g., a UI element in which letters of option 1 are written) capable of showing each of the options is selected by the user, display the UI element 60 corresponding to the selected option. In still another example, the terminal device 200 may display the UI element 60 corresponding to the plurality of options one by one according to a swiping interaction if an input corresponding to an interaction of swiping the screen left or right or top to bottom is received from the user.

The terminal device 200 may receive a user input corresponding to a selection of an option. The terminal device 200 may receive a user input for selecting one from among at least one option corresponding to the substitute position from the user.

The processor 111 may control, based on receiving a user input corresponding to transmitted data through the terminal device 200, at least one from among the driving part 120 and the projection part 112 to project the moving image from the substitute position corresponding to the user input.

Meanwhile, the processor 111 may control at least one from among the driving part 120 and the projection part 112 to project the moving image based on the projection angle and projection position obtained through information about the edited projection area 11 based on not receiving the following user input corresponding to editing of the UI element 20 for a predetermined time or more while the UI element 20 is being edited through the terminal device 200.

The terminal device 200 may receive a plurality of user inputs for editing the UI element 20 from the user. The terminal device 200 may transmit, based on not receiving the following user input for editing the UI element 20 for a predetermined time or more from the user while the UI element 20 is being edited, information about the UI element that was edited so far to the electronic apparatus 100.

The processor 111 may receive the information about the edited UI element from the terminal device 200 through the communication interface 114. The processor 111 may obtain the projection position and projection pose for projecting the moving image onto the edited projection area 11 corresponding to the edited UI element. The processor 111 may control at least one from among the driving part 120 and the projection part 112 to project the moving image to the obtained projection position and projection pose. Even if editing of the UI element 20 is not completed by the user, because the electronic apparatus 100 can project the moving image onto the edited projection area 11 corresponding to the edited UI element, the user may effectively edit due to being able to check the edited screen.

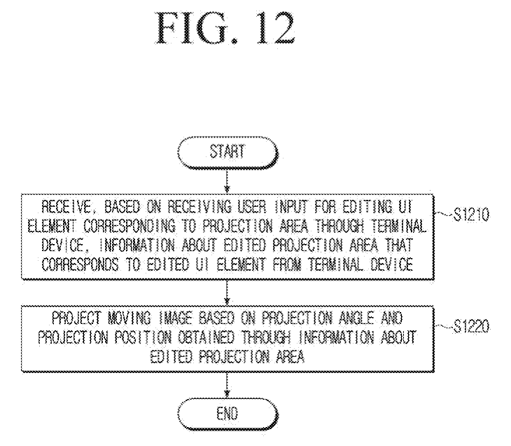

FIG. 12 is a flowchart illustrating a control method of the electronic apparatus 100 according to an embodiment of the disclosure.

The electronic apparatus 100 may receive, based on receiving a user input for editing the UI element 20 corresponding to the projection area of the moving image from the terminal device 200, information about the edited projection area corresponding to the edited UI element from the terminal device (S1210).

The terminal device 200 may display the edited UI element based on receiving a user input for editing the UI element 20 while displaying the UI element 20 corresponding to the current projection area 10 on the image 30 that captured the current projection area 10. Specifically, the edited UI element may be displayed based on receiving the user input for editing at least one from among the size, the form, and the position of the UI element 20.

The electronic apparatus 100 may receive information about the edited projection area 11 corresponding to the edited UI element from the terminal device 200. The information about the edited projection area 11 may include information about the UI element 20 corresponding the current projection area 10 and information about the edited UI element. The information about the UI element 20 may include information about the size, the position, the rotation, and the tilt of the UI element 20. According to still another embodiment, the information about the edited projection area 11 may include information about a difference with the UI element 20 corresponding to the current projection area 10 for at least one from among the size, the position, the rotation, and the tilt of the edited UI element.

The electronic apparatus 100 may project the moving image based on the projection angle and projection position obtained through the information about the edited projection area (S1220). Specifically, the electronic apparatus 100 may control at least one from among the driving part 120 and the projection part 112 to project the moving image onto the edited projection area 11 that corresponds to the edited UI element.

The electronic apparatus 100 may obtain the projection position and projection angle for projecting the moving image onto the edited projection area 11. The projection angle may be an angle for the electronic apparatus 100 to project the moving image onto the projection surface. The projection position may be a position for the electronic apparatus 100 to project the moving image onto the projection surface.

The electronic apparatus 100 may move to the projection position for projecting the moving image onto the projection area 11 corresponding to the edited UI element and project the moving image at the projection angle corresponding to the projection area 10.

The various embodiments described above may be implemented on its own for each embodiment, but is not necessarily limited thereto, and may be implemented together combined as a whole or partially with at least one of the other embodiments.

Methods according to the various embodiments of the disclosure described above may be implemented with only a software upgrade, or a hardware upgrade for the electronic apparatus 100 of the related art.

Meanwhile, according to an embodiment of the disclosure, a control method according to the various embodiments described above may be implemented with software including instructions stored in various non-transitory machine-readable storage media (e.g., computer) such as the electronic apparatus 100.

Specifically, when receiving a user input for editing the UI element corresponding to the projection area through the terminal device, a program for performing a control method that includes receiving information about the edited projection area corresponding to the edited UI element from the terminal device and projecting the moving image based on the projection angle and the projection position obtained through the information about the edited projection area may be provided stored in a non-transitory computer-readable recording medium.

When stored software or instructions are executed by the processor 111, the processor 111 may directly or using other elements perform an operation according to the various embodiments described above. The instructions may include a code generated by a compiler or executed by an interpreter. Here, ‘non-transitory’ merely means that a storage medium is tangible and does not include a signal, and the term does not differentiate data being semi-permanently stored or being temporarily stored in the storage medium.

In addition, according to one or more embodiments of the disclosure, a method according to the various embodiments described above may be provided included a computer program product. The computer program product may be exchanged between a seller and a purchaser as a commodity. The computer program product may be distributed in not only the above-described non-transitory readable recording medium, but also via on-line through an on-line store. In the case of online distribution, at least a portion of the computer program product may be stored at least temporarily in storage media such as a server of a manufacturer, a server of an application store, or a memory of a relay server, or temporarily generated.

In addition, each of the elements (e.g., a module or a program) according to the various embodiments described above may be configured as a single entity or a plurality of entities, and a portion of sub-elements of the above-mentioned relevant sub-elements may be omitted, or other sub-elements may be further included in the various embodiments. Alternatively or additionally, a portion of the elements (e.g., modules or programs) may be integrated into one entity to perform the same or similar functions performed by the respective relevant elements prior to integration. Operations performed by a module, a program, or another element, in accordance with various embodiments, may be executed sequentially, in a parallel, repetitively, or in a heuristic manner, or at least a portion of the operations may be executed in a different order, omitted or a different operation may be added.

While the disclosure has been illustrated and described with reference to example embodiments thereof, it will be understood that the embodiments are intended to be illustrative, not limiting. It will be understood by those skilled in the art that various changes in form and details may be made therein without departing from the true spirit and full scope of the disclosure, including the appended claims and their equivalents.

What is claimed is:

1. An electronic apparatus, comprising:
a communication interface;
a driving part configured to move the electronic apparatus;
a projection part configured to project a moving image;
a memory configured to store instructions; and
at least one processor configured to, collectively or individually, execute the stored instructions to:
based on a user input to edit a user interface (UI) element corresponding to a projection area received through a terminal device,
receive, through the communication interface, information about an edited projection area that corresponds to the edited UI element, and
control the driving part, the projection part, or a combination thereof, such that the moving image is projected based on a projection angle and/or a projection position obtained through the received information.

2. The electronic apparatus of claim 1, wherein
the stored instructions, executed collectively or individually by the at least one processor, are further configured to:
receive, through the communication interface, an image of an area from the terminal device, and
transmit, through the communication interface, information about a projection candidate area in a background area of the received image to the terminal device, the background area including a space between objects included in the received image.

3. The electronic apparatus of claim 2, wherein
the terminal device outputs the edited projection area that corresponds to the edited UI element in the projection candidate area, and
the received information about the edited projection area that corresponds to the edited UI element includes a size of the edited UI element, a form of the edited UI element, a position of the edited UI element, or a combination thereof.

4. The electronic apparatus of claim 3, wherein
the stored instructions, executed collectively or individually by the at least one processor, are further configured to:
based on an obstacle being present in a surrounding of the projection position obtained through the received information,
transmit, through the communication interface, data corresponding to a substitute position for the projection position to the terminal device, and
based on a user input corresponding to the transmitted data received through the terminal device,
control the driving part, the projection part, or a combination thereof, to project the moving image from the substitute position.

5. The electronic apparatus of claim 2, wherein
the stored instructions, executed collectively or individually by the at least one processor, are further configured to:
identify an area of a minimum size or more to which the moving image is projectable as the projection candidate area.

6. The electronic apparatus of claim 2, wherein
the memory is further configured to store three-dimensional (3D) map data, and
the stored instructions, executed collectively or individually by the at least one processor, are further configured to:
control the driving part to move the electronic apparatus to a position corresponding to an area based on the received image and the stored 3D map data.

7. The electronic apparatus of claim 1, wherein
the stored instructions, executed collectively or individually by the at least one processor, are further configured to:
based on the projected moving image,
transmit, through the communication interface, information about a projection area to which the moving image is projected to the terminal device.

8. The electronic apparatus of claim 7, wherein
the terminal device outputs the projection area to which the moving image is projected in an image that captured the projection area, and
the received information about the edited projection area that corresponds to the edited UI element includes a size of the edited UI element, a form of the edited UI element, and a position of the edited UI element, or a combination thereof.

9. The electronic apparatus of claim 8, wherein
the stored instructions, executed collectively or individually by the at least one processor, are further configured to:
based on an obstacle being present in a surrounding of the projection position obtained through the received information,
transmit, through the communication interface, data corresponding to a substitute position for the projection position to the terminal device, and
based on a user input corresponding to the transmitted data received through the terminal device,
control the driving part, the projection part, or a combination thereof, to project the moving image from the substitute position.

10. The electronic apparatus of claim 8, wherein
the user input is a first user input, and
the stored instructions, executed collectively or individually by the at least one processor, are further configured to:
with the UI element edited through the terminal device,
based on a second user input to edit the UI element corresponding to the projection area not being received for a threshold time or more through the terminal device, the second user input subsequent to the first user input, control the driving part, the projection part, or a combination thereof to project the moving image based on the projection angle and/or the projection position obtained through the received information corresponding to the first user input.

11. A control method of an electronic apparatus including a communication interface, a driving part configured to move the electronic apparatus, a projection part configured to project a moving image, and at least one processor, the method comprising:
by the at least one processor, collectively or individually,
based on receiving a user input for editing a user interface (UI) element corresponding to a projection area through a terminal device,
receiving, through the communication interface, information about an edited projection area that corresponds to the edited UI element, and
projecting the moving image based on a projection angle and/or a projection position obtained through the received information.

12. The method of claim 11, further comprising:
by the at least one processor, collectively or individually,
receiving, through the communication interface, an image of an area from the terminal device, and
transmitting, through the communication interface, information about a projection candidate area in a background area of the received image to the terminal device, the background area including a space between objects included in the received image.

13. The method of claim 12, wherein
the terminal device outputs the edited projection area that corresponds to the edited UI element in the projection candidate area, and
the received information about an edited projection area includes a size of the edited UI element, a form of the edited UI element, a position of the UI element, or a combination.

14. The method of claim 13, further comprising:
based on an obstacle being present in a surrounding of the projection position obtained through the received information,
transmitting, through the communication interface, data corresponding to a substitute position for the projection position to the terminal device, and
based on receiving a user input corresponding to the transmitted data through the terminal device,
projecting the moving image from the substitute position.

15. The method of claim 12, wherein
the transmitting information about the projection candidate area to the terminal device includes:
identifying an area of a minimum size or more to which the moving image is projectable as the projection candidate area.

16. A non-transitory computer-readable recording medium including a program for executing a control method for an electronic method including a communication interface, a driving part configured to move the electronic apparatus, a projection part configured to project a moving image, and at least one processor, wherein the method comprising:
by the at least one processor, collectively or individually,
based on receiving a user input for editing a user interface (UI) element corresponding to a projection area through a terminal device,
receiving, through the communication interface, information about an edited projection area that corresponds to the edited UI element, and
projecting the moving image based on a projection angle and/or a projection position obtained through the received information.

17. The non-transitory computer-readable recording medium of claim 16, further comprising:
by the at least one processor, collectively or individually,
receiving, through the communication interface, an image of an area from the terminal device, and
transmitting, through the communication interface, information about a projection candidate area in a background area of the received image to the terminal device, the background area including a space between objects included in the received image.

18. The non-transitory computer-readable recording medium of claim 17, wherein
the terminal device outputs the edited projection area that corresponds to the edited UI element in the projection candidate area, and
the received information about an edited projection area includes a size of the edited UI element, a form of the edited UI element, a position of the UI element, or a combination.

19. The non-transitory computer-readable recording medium of claim 18, further comprising:
based on an obstacle being present in a surrounding of the projection position obtained through the received information,
transmitting, through the communication interface, data corresponding to a substitute position for the projection position to the terminal device, and
based on receiving a user input corresponding to the transmitted data through the terminal device,
projecting the moving image from the substitute position.

20. The non-transitory computer-readable recording medium of claim 17, wherein
the transmitting information about the projection candidate area to the terminal device includes:
identifying an area of a minimum size or more to which the moving image is projectable as the projection candidate area.
